(19) United States
(12) Patent Application Publication
(10) Pub. No.: US 2024/0258018 A1
(43) Pub. Date: Aug. 1, 2024

(54) COIL COMPONENT

(71) Applicant: Murata Manufacturing Co., Ltd., Kyoto-fu (JP)

(72) Inventors: Shigeto YAMAMOTO, Nagaokakyo-shi (JP); Ryota HASHIMOTO, Nagaokakyo-shi (JP); Shingo NAKAMOTO, Nagaokakyo-shi (JP); Masashi MIYAMOTO, Nagaokakyo-shi (JP)

(73) Assignee: Murata Manufacturing Co., Ltd., Kyoto-fu (JP)

(21) Appl. No.: 18/421,097

(22) Filed: Jan. 24, 2024

(30) Foreign Application Priority Data
Jan. 30, 2023 (JP) 2023-011901

(51) Int. Cl. H01F 27/28

(52) U.S. Cl. CPC H01F 27/2828

(57) ABSTRACT

A coil component includes first and second wound areas along an axis direction of a winding core portion. In the first wound area, a first wire is wound as a first layer. A second wire is wound as a second layer in a recessed portion between adjacent turns of the first wire, returned from an end portion on a second end portion side to a first end portion side and guided to an outer peripheral side of the second layer, wound as a third layer, guided to a position of the second layer on an outer peripheral side of the first layer, and wound as the second layer in a recessed portion between adjacent turns of the first wire of the first layer. In the second wound area, a layer in which each of the first and second wires in the first wound area is located is replaced.

### CROSS-REFERENCE TO RELATED APPLICATION

This application claims benefit of priority to Japanese Patent Application No. 2023-011901, filed Jan. 30, 2023, the entire content of which is incorporated herein by reference.

### BACKGROUND

### Technical Field

The present disclosure relates to a coil component, and in particular, relates to an improvement in a wire winding aspect in a wire-wound coil component having a structure in which two wires are wound in a state of forming a plurality of layers around a winding core portion.

### Background Art

In the present case, the n-th turn of each of a first wire and a second wire wound around the winding core portion is expressed as a “turn Tn” (n is a natural number).

Regarding the amount of shift between the first wire and the second wire, for example, in a case where the turn Tn of one wire is fitted in a recessed portion between the turn Tn and the turn Tn+1 of the other wire, the amount of shift is defined as “0.5 turns”. In a case where the turn Tn+2 turn of one wire is fitted in a recessed portion between the turn Tn and the n+1 turn of the other wire, the amount of shift is defined as “1.5 turns”. In a case where the turn Tn+3 turn of one wire is fitted in a recessed portion between the turn Tn and the n+1 turn of the other wire, the amount of shift is defined as “2.5 turns”.

Regarding the direction of a shift between the first wire and the second wire, in a case where the turn of the second wire is on a terminal end side in the winding direction from the turn of the first wire with the same number as that of the second wire, the shift is defined as a shift in the positive direction, and a “+” is added before the number representing the amount of shift, and in the opposite case, the shift is defined as a shift in the negative direction, and a “−” is added before the number representing the amount of shift.

When the turns of the wire are counted, it does not matter whether the turns of the wire are counted from a first end portion side of the winding core portion or, conversely, from a second end portion side thereof. Even when the direction where the number of turns is counted is reversed, it can be said that it is essentially the same configuration.

In addition, in the present case, among a plurality of layers formed by the wire wound around the winding core portion, a layer closest to a peripheral surface of the winding core portion, that is, a layer at least partially in contact with the peripheral surface of the winding core portion is referred to as a first layer, a layer that is wound on an outer peripheral side of the first layer while being fitted in a recessed portion formed between adjacent turns of the wire located in the first layer is referred to as a second layer, and a layer that is wound on an outer peripheral side of the second layer while being fitted in a recessed portion formed between adjacent turns of the wire located in the second layer is referred to as a third layer. The reason why that the first layer, which is the layer closest to the peripheral surface of the winding core portion, is at least partially in contact with the peripheral surface of the winding core portion is that normally the wire is not in contact with the peripheral surface of the winding core portion over the entire length, for example, the wire is in contact with only a ridge portion of the winding core portion having a rectangular cross section, and the other portions are slightly lifted from the peripheral surface of the winding core portion.

As a representative example of the coil component to which the present disclosure is directed, there is a common mode choke coil.

A common mode choke coil of interest to the present disclosure is described in, for example, Japanese Patent No. 6327397. FIG. 15A is a cross-sectional view schematically showing a characteristic configuration in a winding state of two wires 81 and 82 provided in a coil component 80 which is a common mode choke coil described in Japanese Patent No. 6327397. FIG. 15A corresponds to FIG. 2, FIG. 7, or FIG. 8 in Japanese Patent No. 6327397. FIG. 15B is a view for describing a problem that will be described later.

In FIGS. 15A and 15B, the cross section showing a first wire 81 is hatched so that the first wire 81 and a second wire 82 can be clearly distinguished. The first wire 81 and the second wire 82 are spirally wound around a winding core portion 83 with substantially the same number of turns as each other from a first end portion 84 of the winding core portion 83 toward an opposite second end portion 85. The first wire 81 is wound in a state of constituting a first layer in contact with the peripheral surface of the winding core portion 83, and the second wire 82 is wound in a state of constituting a second layer outside the first layer while most of the second wire 82 is fitted in a recessed portion formed between adjacent turns of the first wire 81.

As described above, the reason why most of the second wire 82 is wound in a state of constituting the second layer outside the first layer is that a part of turns, for example, turn Tm and turn Tm+1 (m is a natural number) of the second wire 82 are wound to be in contact with the peripheral surface of the winding core portion 83.

In addition, in FIGS. 15A and 15B, each of the plurality of turns of the first wire 81 and a corresponding one of the plurality of turns of the second wire 82 are connected to each other by a line segment. As described above, the turns connected by the line segment indicate that the turns are the same number of turns when counted from the first end portion 84.

The coil component 80 described in Japanese Patent No. 6327397 is developed for the purpose of reducing the mode conversion characteristics in a common mode choke coil, and the embodiment shown in FIG. 15A has the following features.

That is, when expressed by the number of turns n counted from the first end portion 84 side of each of the first wire 81 and the second wire 82, the coil component 80 includes (1) a +0.5 turn shift area 87 in which a turn is shifted in the positive direction by 0.5 turns between the first wire and the second wire, by fitting the turn Tn of the second wire 82 in a recessed portion between the turn Tn and the turn Tn+1 of the first wire 81, (2) a −1.5 turn shift area 88 in which a turn is shifted in the negative direction by 1.5 turns between the first wire 81 and the second wire 82, by fitting the turn Tn+2 of the second wire 82 in the recessed portion between the turn Tn and the turn Tn+1 of the first wire 81, and (3) a transition area 89 that transitions from the +0.5 turn shift area 87 to the −1.5 turn shift area 88.

The sum of the number of turns of the second wire 82 located in the 0.5 turn shift area 87 is two or more times and five times or less (i.e., from two to five) the sum of the number of turns of the second wire 82 located in the 1.5 turn shift area 88.

With such a configuration, the capacitance generated between the first wire 81 and the second wire 82 can be balanced between the first wire 81 and the second wire 82 as a whole, and the influence of stray capacitance generated between the first wire 81 and the second wire 82 can be reduced. Therefore, for example, in the common mode choke coil, the mode conversion characteristics can be reduced.

### SUMMARY

Focusing on the second wire 82 in the winding state shown in FIG. 15A, since no wire is in contact with the first end portion 84 side of the turn Tm+2 at a start end of the −1.5 turn shift area 88, the turn Tm+2 is likely to be shifted in the direction indicated by the arrow 90 in FIG. 15A. In addition, for the turn Tm+1 at a terminal end of the transition area 89, the wire is not in contact with the first end portion 84 side thereof. As a result, as shown in FIG. 15B, the turn Tm+2 may climb over the turn Tm+1 and fall between the turn Tm and the turn Tm+1. Although not shown in FIG. 15B, in a case where the distance between the turn Tm and the turn Tm+1 is wider, the turn Tm+2 may be in contact with the peripheral surface of the winding core portion 83.

Although inadvertent stepping of the turn Tm+2 as described above, that is, the inadvertent positional shift of the turn Tm+2 to be located in the second layer from the second layer in the first layer direction, may occur in the finished product of the coil component 80, when the inadvertent stepping occurs in the step of winding the second wire 82 from the first end portion 84 toward the second end portion 85, the positional shift may sequentially occur in subsequent turns Tm+3, . . . . Therefore, the shift area 88 is not a −1.5 turn shift area, and is, for example, a −2.5 turn shift area. As a result, the balance of the capacitance generated between the first wire 81 and the second wire 82 may be lost, and the mode conversion characteristics may deteriorate.

The same type of positional shift problem can be encountered not only in the common mode choke coil, but also in, for example, a wire-wound chip transformer including a first wire and a second wire.

Therefore, the present disclosure provides a coil component in which a positional shift of a wire wound in a state of forming a plurality of layers around a winding core portion is unlikely to occur.

The present disclosure is directed to a coil component including a core that includes a winding core portion having a first end portion and a second end portion opposite to each other in an axis direction, and a first wire and a second wire spirally wound around the winding core portion with substantially the same number of turns as each other.

Hereinafter, among a plurality of layers formed by the wire wound around the winding core portion, a layer closest to a peripheral surface of the winding core portion is referred to as a first layer, a layer that is wound on an outer peripheral side of the first layer while being fitted in a recessed portion formed between adjacent turns of the wire located in the first layer is referred to as a second layer, and a layer that is wound on an outer peripheral side of the second layer while being fitted in a recessed portion formed between adjacent turns of the wire located in the second layer is referred to as a third layer.

The present disclosure has a first aspect, a second aspect, and a third aspect due to a subtle difference in the winding states of the first wire and the second wire. The first, second, and fourth to tenth embodiments described later have the features of the first aspect, the third and eleventh embodiments have the features of the second aspect, and the twelfth embodiment has the features of the third aspect.

A first aspect is provided with the following configuration.

A plurality of wound areas including at least a first wound area and a second wound area in which winding states of the first wire and the second wire are different from each other are disposed along the axis direction.

The first wound area includes (1-1) a first wound portion in which the first wire is wound from a first end portion toward a second end portion in a first layer, (1-2) a second wound portion in which the second wire is wound to a middle of a range where the first wound portion extends from the first end portion toward the second end portion in a second layer, (1-3) a first transfer portion in which the second wire is changed in a direction from an end portion of the second wound portion on a second end portion side to a first end portion side and is guided to a position of a third layer, (1-4) a third wound portion in which the second wire is connected to the first transfer portion and is wound by N turns (N is a natural number) in the third layer, (1-5) a second transfer portion in which the second wire is guided from the third wound portion to a position of the second layer, and (1-6) a fourth wound portion in which the second wire is connected to the second transfer portion and is wound toward the second end portion in the second layer.

A layer in which each of the first wire and the second wire is respectively located is replaced between the first wound area and the second wound area.

The second wound area includes (2-1) a fifth wound portion in which the second wire is wound from the first end portion toward the second end portion in the first layer, (2-2) a sixth wound portion in which the first wire is wound to a middle of a range where the fifth wound portion extends from the first end portion toward the second end portion in the second layer, (2-3) a third transfer portion in which the first wire is changed in a direction from an end portion of the sixth wound portion on the second end portion side to the first end portion side and is guided to a position of the third layer, (2-4) a seventh wound portion in which the first wire is connected to the third transfer portion and is wound by M turns (M is a natural number) in the third layer, (2-5) a fourth transfer portion in which the first wire is guided from the seventh wound portion to a position of the second layer, and (2-6) an eighth wound portion in which the first wire is connected to the fourth transfer portion and is wound toward the second end portion in the second layer.

Regarding a direction of a shift between the first wire and the second wire, when the shift is defined as a shift in a positive direction in a case where a turn of the second wire is on the second end portion side from a turn of the first wire with the same number as the turn of the second wire, and the shift is defined as a shift in a negative direction in an opposite case, a positive direction shift area in which a turn is shifted in the positive direction and a negative direction shift area in which a turn is shifted in the negative direction between the first wire and the second wire are present in each of the first wound area and the second wound area.

A second aspect is provided with the following configuration.

A plurality of wound areas including at least a first wound area and a second wound area in which winding states of the first wire and the second wire are different from each other are disposed along the axis direction.

The first wound area includes (1-1) a first wound portion in which the first wire is wound from a first end portion toward a second end portion in a first layer, (1-2) a second wound portion in which the second wire is wound to a middle of a range where the first wound portion extends from the first end portion toward the second end portion in a second layer, (1-3) a first transfer portion in which the second wire is changed in a direction from an end portion of the second wound portion on a second end portion side to a first end portion side and is guided to a position of a third layer, (1-4) a third wound portion in which the second wire is connected to the first transfer portion and is wound by N turns (N is a natural number) in the third layer, (1-5) a second transfer portion in which the second wire is guided from the third wound portion to a position of the first layer, (1-6) a fourth wound portion in which the second wire is connected to the second transfer portion and is wound toward the second end portion in the first layer, (1-7) a third transfer portion in which the first wire is changed in a direction from an end portion of the first wound portion on the second end portion side to the first end portion side and is guided to a position of the second layer, and (1-8) a fifth wound portion in which the first wire is connected to the third transfer portion and is wound toward the second end portion in the second layer.

A layer in which each of the first wire and the second wire is respectively located is replaced between the first wound area and the second wound area.

The second wound area includes (2-1) a sixth wound portion in which the second wire is wound from the first end portion toward the second end portion in the first layer, (2-2) a seventh wound portion in which the first wire is wound to a middle of a range where the sixth wound portion extends from the first end portion toward the second end portion in the second layer, (2-3) a fourth transfer portion in which the first wire is changed in a direction from an end portion of the seventh wound portion on the second end portion side to the first end portion side and is guided to a position of the third layer, (2-4) an eighth wound portion in which the first wire is connected to the fourth transfer portion and is wound by M turns (M is a natural number) in the third layer, (2-5) a fifth transfer portion in which the first wire is guided from the eighth wound portion to a position of the first layer, (2-6) a ninth wound portion in which the first wire is connected to the fifth transfer portion and is wound toward the second end portion in the first layer, (2-7) a sixth transfer portion in which the second wire is changed in a direction from an end portion of the sixth wound portion on the second end portion side to the first end portion side and is guided to a position of the second layer, and (2-8) a tenth wound portion in which the second wire is connected to the sixth transfer portion and is wound toward the second end portion in the second layer.

Regarding a direction of a shift between the first wire and the second wire, when the shift is defined as a shift in a positive direction in a case where a turn of the second wire is on the second end portion side from a turn of the first wire with the same number as the turn of the second wire, and the shift is defined as a shift in a negative direction in an opposite case, a positive direction shift area in which a turn is shifted in the positive direction and a negative direction shift area in which a turn is shifted in the negative direction between the first wire and the second wire are present in each of the first wound area and the second wound area.

The second aspect is different from the first aspect in that the second wire is guided from the third wound portion to the position of the first layer instead of the second layer in the second transfer portion, and the first wire is guided from the seventh wound portion to the position of the first layer instead of the second layer in the fourth transfer portion.

A third aspect is provided with the following configuration.

A plurality of wound areas including at least a first wound area and a second wound area are disposed along the axis direction.

The first wound area includes (1-1) a first wound portion in which the first wire is wound from a first end portion toward a second end portion in a first layer, (1-2) a second wound portion in which the second wire is wound to a middle of a range where the first wound portion extends from the first end portion toward the second end portion in a second layer, (1-3) a first transfer portion in which the second wire is changed in a direction from an end portion of the second wound portion on a second end portion side to a first end portion side and is guided to a position of a third layer, (1-4) a third wound portion in which the second wire is connected to the first transfer portion and is wound by N turns (N is a natural number) in the third layer, (1-5) a second transfer portion in which the second wire is guided from the third wound portion to a position of the first layer, (1-6) a fourth wound portion in which the second wire is connected to the second transfer portion and is wound toward the second end portion in the first layer, (1-7) a third transfer portion in which the first wire is changed in a direction from an end portion of the first wound portion on the second end portion side to the first end portion side and is guided to a position of the second layer, and (1-8) a fifth wound portion in which the first wire is connected to the third transfer portion and is wound toward the second end portion in the second layer.

In the first wound area, a layer in which the first wire is located is replaced between the first wound portion and the fifth wound portion, and a layer in which the second wire is located is replaced between the second wound portion and the fourth wound portion.

The second wound area includes (2-1) a sixth wound portion in which the first wire is wound from the first end portion toward the second end portion in the first layer, (2-2) a seventh wound portion in which the second wire is wound to a middle of a range where the sixth wound portion extends from the first end portion toward the second end portion in the second layer, (2-3) a fourth transfer portion in which the second wire is changed in a direction from an end portion of the seventh wound portion on the second end portion side to the first end portion side and is guided to a position of the third layer, (2-4) an eighth wound portion in which the second wire is connected to the fourth transfer portion and is wound by M turns (M is a natural number) in the third layer, (2-5) a fifth transfer portion in which the second wire is guided from the eighth wound portion to a position of the first layer, (2-6) a ninth wound portion in which the second wire is connected to the fifth transfer portion and is wound toward the second end portion in the first layer, (2-7) a sixth transfer portion in which the first wire is changed in a direction from an end portion of the sixth wound portion on the second end portion side to the first end portion side and is guided to a position of the second layer, and (2-8) a tenth wound portion in which the first wire is connected to the sixth transfer portion and is wound toward the second end portion in the second layer.

In the second wound area, a layer in which the first wire is located is replaced between the sixth wound portion and the tenth wound portion, and a layer in which the second wire is located is replaced between the seventh wound portion and the ninth wound portion.

Regarding a direction of a shift between the first wire and the second wire, when the shift is defined as a shift in a positive direction in a case where a turn of the second wire is on the second end portion side from a turn of the first wire with the same number as the turn of the second wire, and the shift is defined as a shift in a negative direction in an opposite case, a positive direction shift area in which a turn is shifted in the positive direction and a negative direction shift area in which a turn is shifted in the negative direction between the first wire and the second wire are present in each of the first wound area and the second wound area.

The first aspect and the second aspect differ in that the layer in which each of the first wire and the second wire is located is replaced between the first wound area and the second wound area, whereas in the third aspect, the layer in which each of the first wire and the second wire is located is replaced in each of the first wound area and the second wound area.

### Coil Component.

According to the present disclosure, since the wire located in the second layer, where there is a concern about inadvertent stepping, is changed in the direction from the end portion on the second end portion side to the first end portion side, is guided to the position of the third layer, and is wound by N turns or M turns in the third layer, it is possible to make a positional shift of the wire located in the second layer be unlikely to occur.

In addition, in each of the first wound area and the second wound area, since the positive direction shift area in which the turn is shifted in the positive direction and the negative direction shift area in which the turn is shifted in the negative direction between the first wire and the second wire are present, it is possible to reduce the influence of stray capacitance generated between the first wire and the second wire.

In addition, according to the present disclosure, since the wire located in the first layer and the wire located in the second layer are replaced between the first wire and the second wire, a difference between the length of the first wire and the length of the second wire can be reduced.

With these configurations, for example, the mode conversion characteristics can be reduced in the common mode choke coil.

### BRIEF DESCRIPTION OF THE DRAWINGS

FIG. 1 is an external view of a coil component 1 according to a first embodiment of the present disclosure, and shows a surface that is oriented toward a mounting substrate side;

FIG. 2 is a schematic diagram of a winding state of a first wire and a second wire in the coil component shown in FIG. 1, and is a cross-sectional view taken along the line A-A in FIG. 3 showing a part of a core including a winding core portion around which the first wire and the second wire are wound;

FIG. 3 is an exploded diagram schematically showing a peripheral surface of the winding core portion around which the first wire and the second wire are wound in the coil component shown in FIG. 1;

FIG. 4 is a cross-sectional view schematically showing a part of a winding core portion around which a first wire and a second wire are wound in a coil component according to a second embodiment of the present disclosure;

FIG. 5 is a cross-sectional view schematically showing a part of a winding core portion around which a first wire and a second wire are wound in a coil component according to a third embodiment of the present disclosure;

FIG. 6 is a cross-sectional view schematically showing a part of a winding core portion around which a first wire and a second wire are wound in a coil component according to a fourth embodiment of the present disclosure;

FIG. 7 is a cross-sectional view schematically showing a part of a winding core portion around which a first wire and a second wire are wound in a coil component according to a fifth embodiment of the present disclosure;

FIG. 8 is a cross-sectional view schematically showing a part of a winding core portion around which a first wire and a second wire are wound in a coil component according to a sixth embodiment of the present disclosure;

FIG. 9 is a cross-sectional view schematically showing a part of a winding core portion around which a first wire and a second wire are wound in a coil component according to a seventh embodiment of the present disclosure;

FIG. 10 is a cross-sectional view schematically showing a part of a winding core portion around which a first wire and a second wire are wound in a coil component according to an eighth embodiment of the present disclosure;

FIG. 11 is a cross-sectional view schematically showing a part of a winding core portion around which a first wire and a second wire are wound in a coil component according to a ninth embodiment of the present disclosure;

FIG. 12 is a cross-sectional view schematically showing a part of a winding core portion around which a first wire and a second wire are wound in a coil component according to a tenth embodiment of the present disclosure;

FIG. 13 is a cross-sectional view schematically showing a part of a winding core portion around which a first wire and a second wire are wound in a coil component according to an eleventh embodiment of the present disclosure;

FIG. 14 is a cross-sectional view schematically showing a part of a winding core portion around which a first wire and a second wire are wound in a coil component according to a twelfth embodiment of the present disclosure; and

FIGS. 15A and 15B are cross-sectional views each schematically showing a winding state of two wires provided in the coil component described in Japanese Patent No. 6327397, in which FIG. 15A shows a characteristic configuration of the winding state of two wires, and FIG. 15B is a view for describing issues addressed by the present disclosure.

### DETAILED DESCRIPTION

### First Embodiment

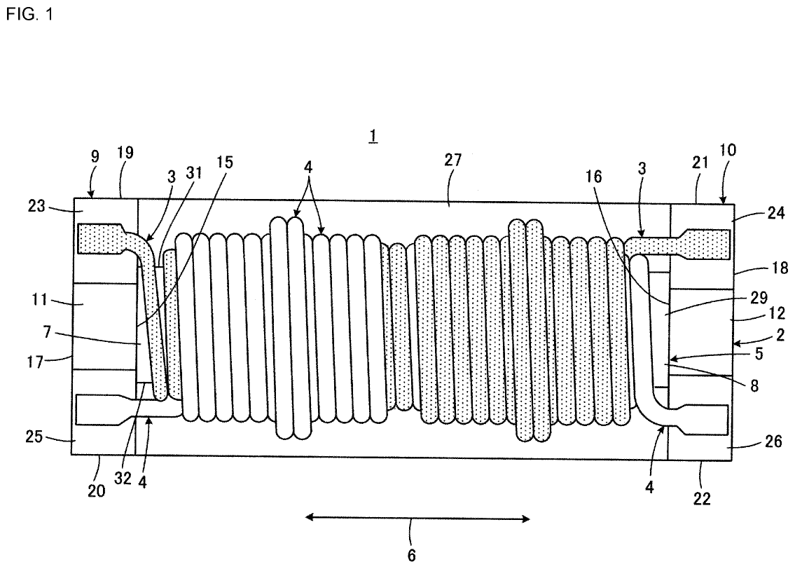

FIG. 1 shows a surface of a coil component 1 according to a first embodiment of the present disclosure that faces a mounting substrate (not shown) side. The coil component 1 becomes a common mode choke coil.

The coil component 1 includes a drum-shaped core 2, and a first wire 3 and a second wire 4 that form an inductor, respectively. The core 2 is made of a non-conductive material, more specifically, a ferrite, such as Ni—Zn, or a resin containing ferrite powder or metal magnetic powder, or the like.

The core 2 includes a first flange portion 9 and a second flange portion 10 provided to protrude from a winding core portion 5, and a first end portion 7 and a second end portion 8 of the winding core portion 5 opposite to each other in the axis direction 6, respectively. A cross section of the winding core portion 5 orthogonal to the axis direction 6 has a quadrangle shape. A ridge portion of the winding core portion 5 having a quadrangle cross-sectional shape may be chamfered, or the cross-sectional shape of the winding core portion 5 may be another polygonal shape such as a hexagonal shape, a circular shape, an elliptical shape, or a shape obtained by appropriately combining these shapes.

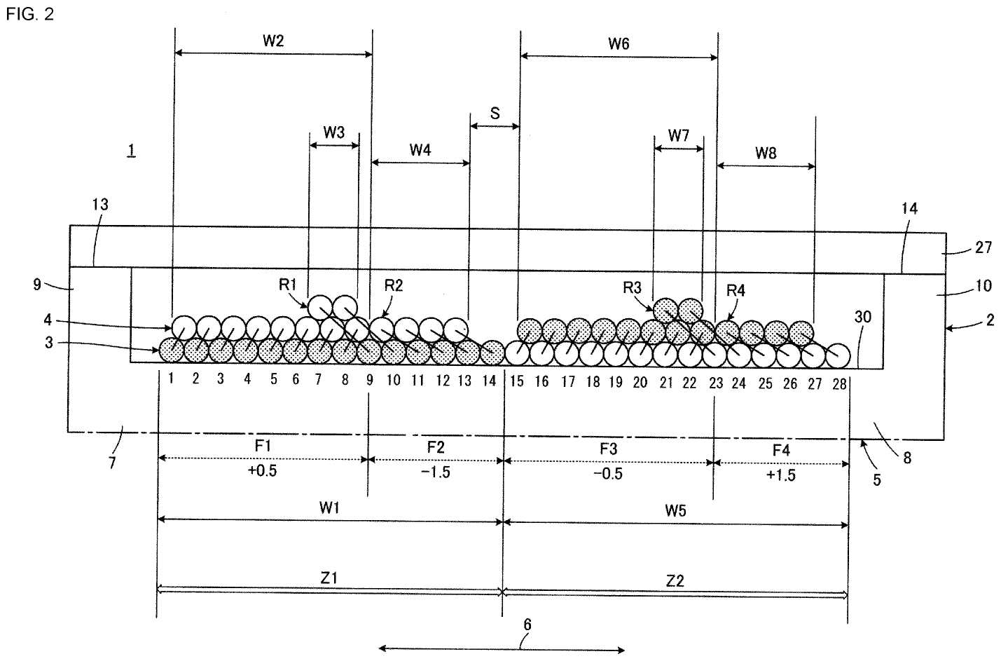

The first flange portion 9 and the second flange portion 10 have a quadrangle prism shape. The first flange portion 9 includes a lower surface 11 facing the mounting substrate side, a top surface 13 (refer to FIG. 2) facing in the direction opposite to the lower surface 11, an inner end surface 15 on which the first end portion 7 of the winding core portion 5 is located, an outer end surface 17 opposite to the inner end surface 15 and facing outward, and a first side surface 19 and a second side surface 20 connecting between the lower surface 11 and the top surface 13 and between the inner end surface 15 and the outer end surface 17. Similarly, the second flange portion 10 includes a lower surface 12 facing the mounting substrate side, a top surface 14 (refer to FIG. 2) facing in the direction opposite to the lower surface 12, an inner end surface 16 on which the second end portion 8 of the winding core portion 5 is located, an outer end surface 18 opposite to the inner end surface 16 and facing outward, and a first side surface 21 and a second side surface 22 connecting between the lower surface 12 and the top surface 14 and between the inner end surface 16 and the outer end surface 18. The ridge portions of the first flange portion 9 and the second flange portion 10 may be chamfered.

The coil component includes four or more terminal electrodes. In this embodiment, the coil component 1 includes four terminal electrodes 23 to 26. A first terminal electrode 23 and a third terminal electrode 25 are provided on the lower surface 11 of the first flange portion 9, and a second terminal electrode 24 and a fourth terminal electrode 26 are provided on the lower surface 12 of the second flange portion 10. Although not shown, the first terminal electrode 23 and the third terminal electrode 25 may extend to a part of the outer end surface 17 of the first flange portion 9, and the second terminal electrode 24 and the fourth terminal electrode 26 may extend to a part of the outer end surface 18 of the second flange portion 10.

For example, the terminal electrodes 23 to 26 are formed by baking a conductive paste containing silver as a conductive component onto the lower surfaces 11 and 12, vapor-depositing silver on the portions extending to the outer end surfaces 17 and 18, and then plating these underlying conductor films with copper, nickel, and tin in that order. The terminal electrodes 23 to 26 may be provided by attaching a metal terminal made of a conductive metal plate to the core 2, for example, by using an epoxy based adhesive agent.

The first wire 3 and the second wire 4 are spirally wound around the winding core portion 5. In FIG. 1, the first wire 3 is hatched so that the first wire 3 and the second wire 4 can be clearly distinguished. The details of the winding state of the first wire 3 and the second wire 4 will be described later. For example, the first wire 3 and the second wire 4 include a linear central conductor made of a good conductive metal such as copper, silver, or gold, and the central conductor is covered with an electrically insulating coating made of resin such as polyurethane or polyamide-imide. The diameter of the linear central conductor is not particularly limited. In addition, the number of turns of the first wire 3 and the second wire 4 is not particularly limited. Preferably, the diameters of the first wire 3 and the second wire 4 are 20 to 100 μm.

Each end portion of the first wire 3 is connected to the first terminal electrode 23 and the second terminal electrode 24, and each end portion of the second wire 4 is connected to the third terminal electrode 25 and the fourth terminal electrode 26. For example, thermal pressure bonding is applied to these connections.

The coil component 1 may further include a top plate 27. The top plate 27 is for forming a closed magnetic path in cooperation with the core 2, and is made of ferrite, which is the same material as that of the core 2, a non-conductive magnetic material other than ferrite, or a resin containing ferrite powder or metal magnetic powder. The top plate 27 is bonded to the top surface 13 of the first flange portion 9 and the top surface 14 of the second flange portion 10 with an adhesive interposed therebetween in a state of being passed between the first flange portion 9 and the second flange portion 10 of the core 2. As the adhesive, a thermosetting epoxy resin or a composite magnetic resin obtained by adding metal magnetic powder or ferrite powder having a particle size of 0.1 to 10 m to a thermosetting epoxy resin is preferably used. An inorganic filler, such as a silica filler or an inorganic magnetic powder, may be added to the adhesive to improve thermal shock resistance. A method of applying the adhesive includes a method of dipping the top surfaces 13 and 14 sides of the flange portions 9 and 10 of the core 2 in the adhesive, a method of dispensing or printing with the adhesive on the surface of the top plate 27 on the core 2 side, and the like.

A resin coating may be applied instead of the top plate 27. In addition, both the top plate 27 and the coating may be absent.

The coil component 1 is manufactured, for example, as follows.

To manufacture the core 2, for example, ferrite powder is press-molded in a mold, the obtained formed body is fired, and after firing, the formed body is barrel-polished to remove burrs.

Next, to provide the terminal electrodes 23 to 26 on the obtained core 2, an underlying conductor film is formed and thereafter barrel plating is performed.

Next, the wires 3 and 4 are discharged from the nozzle and are wound around the winding core portion 5 of the core 2. In the wires 3 and 4, in order to achieve a winding state described in detail later, for example, the second wire 4 is wound while the first wire 3 is being wound, or the first wire 3 is wound while the second wire 4 is being wound. After the winding, the end portion of the first wire 3 is thermal pressure bonded to the first terminal electrode 23 and the second terminal electrode 24, and the end portion of the second wire 4 is thermal pressure bonded to the third terminal electrode 25 and the fourth terminal electrode 26 by the heater chip. The excess of the wires 3 and 4 connected to the terminal electrodes 23 to 26 are cut and removed by the cut blade.

Thereafter, the top plate 27 is adhered to the core 2 by an adhesive. In this manner, the coil component 1 is completed. The dimensions of the coil component 1 are not particularly limited, but for example, the dimension in the axis direction 6 is 3.2 mm, the dimension in the width direction (up-down direction in FIG. 1) is 2.5 mm, and the dimension in the height direction (direction orthogonal to the paper surface in FIG. 1) is 2.5 mm.

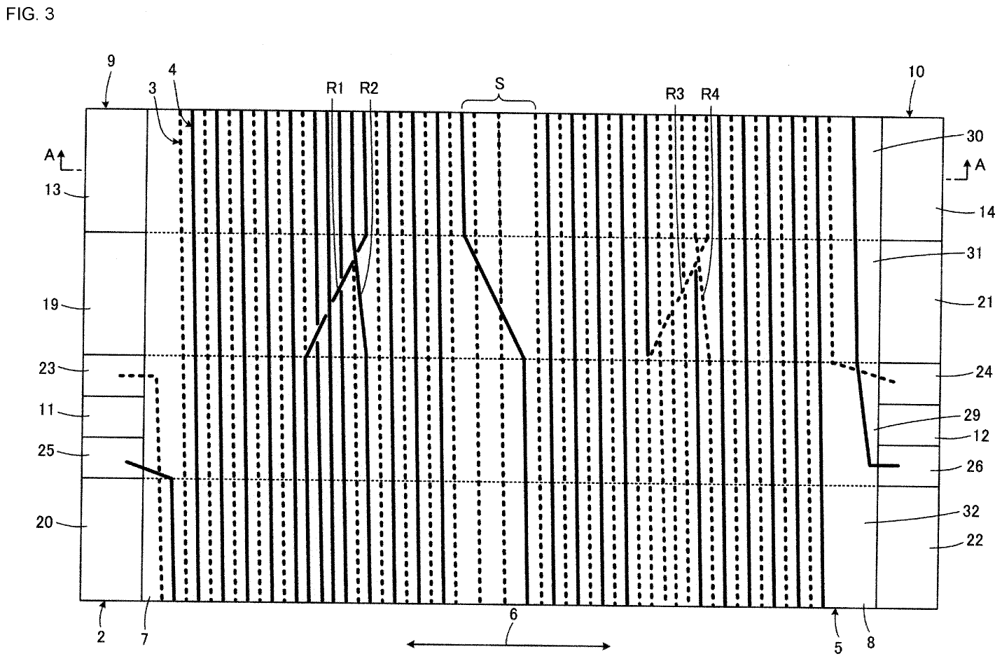

The winding state of the first wire 3 and the second wire 4 in the coil component 1 shown in FIG. 1 will be described mainly with reference to FIGS. 2 and 3. FIG. 2 shows a cross-sectional view of a part of the winding core portion 5 around which the first wire 3 and the second wire 4 are wound. FIG. 3 is an exploded diagram of the peripheral surface of the winding core portion 5 around which the first wire 3 and the second wire 4 are wound.

In FIG. 2, the cross section showing the first wire 3 is hatched so that the first wire 3 and the second wire 4 can be clearly distinguished. The first wire 3 and the second wire 4 are spirally wound around the winding core portion 5 and have substantially the same number of turns as each other.

In FIG. 2, each of the plurality of turns of the first wire 3 and each of the plurality of turns of the second wire 4 are connected by a line segment. As described above, the turns connected by the line segment indicate that the turns are the same number of turns when counted from the first end portion 7. A number is written below each turn of the wire 3 or 4 located in the first layer. These numbers indicate the number of turns of each turn of the wire 3 or 4 located in the first layer. Therefore, each turn of one of the wires 3 and 4 and each of the other turns of the wires 3 and 4 connected by a line segment are also turns of the same number as the above-described numbers. In the winding state shown in FIG. 2, both the first wire 3 and the second wire 4 have turns T1 to T28.

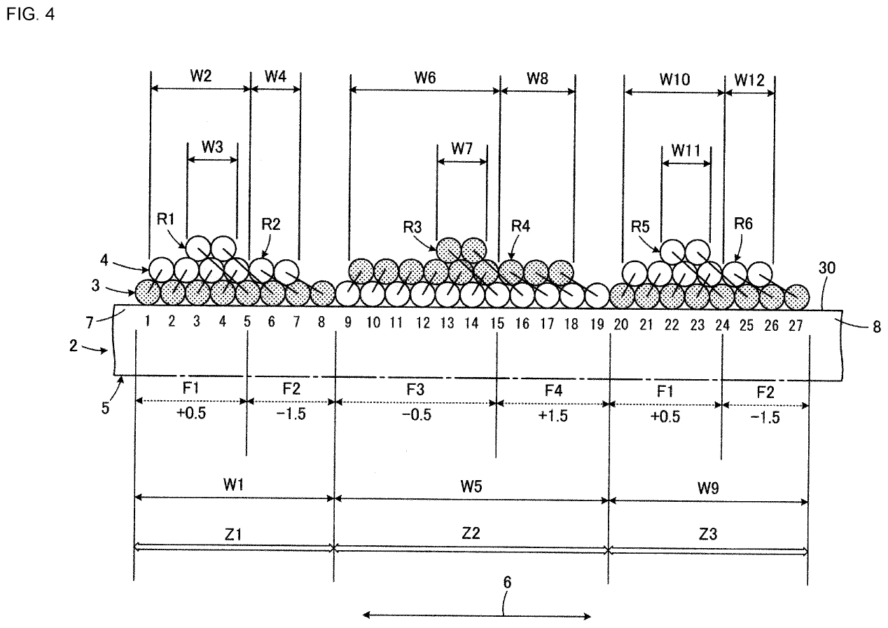

The description of a drawing method for FIG. 2 above also applies to FIGS. 4 to 14 described later.

As described above, the first flange portion 9 and the second flange portion 10 have a quadrangle prism shape, and each includes the peripheral surface having the lower surfaces 11 and 12, the top surface 13 and 14, the first side surfaces 19 and 21, and the second side surfaces 20 and 22. On the other hand, the cross section orthogonal to the axis direction 6 of the winding core portion 5 has a quadrangle shape, and four surfaces are formed on the peripheral surface thereof. Therefore, for the four surfaces of the peripheral surface of the winding core portion 5, the names of the surfaces that face in the same direction as each of the lower surface, the top surface, the first side surface, and the second side surface of the flange portions 9 and 10 are similarly referred to as the “lower surface”, “top surface”, “first side surface”, and “second side surface”.

As shown in FIG. 3, the winding core portion 5 has a lower surface 29, a top surface 30, a first side surface 31, and a second side surface 32 on the peripheral surface. FIG. 2 shows a cross section along the line A-A in FIG. 3, that is, a cross section of the wires 3 and 4 on the top surface 30 of the winding core portion 5.

In FIG. 3, the first wire 3 is indicated by a thick dotted line, and the second wire 4 is indicated by a thick solid line. Actually, the wires of the first layer are almost hidden by the wires of the second layer, but in the exploded diagram of FIG. 3, the thick dotted line indicates the position of the central axis line of the first wire 3, and the thick solid line indicates the position of the central axis line of the second wire 4. Therefore, the first wire 3 of the first layer and the second wire 4 of the second layer are shown adjacent to each other, and the second wire 4 of the first layer and the first wire 3 of the second layer are shown adjacent to each other. As can be understood from FIG. 3, the wire 3 or 4 of the third layer and the wire 3 or 4 of the second layer that is in contact with the wire 3 or 4 of the third layer are also shown adjacent to each other. The turn of the wire 3 or 4 of the first layer immediately below the turn of the wire 3 or 4 of the third layer is not shown.

In the coil component 1 shown in FIGS. 1 to 3, a plurality of wound areas in which the winding states of the first wire 3 and the second wire 4 are different from each other, for example, a first wound area Z1 and a second wound area Z2 are disposed along the axis direction 6 of the winding core portion 5.

Referring mainly to FIG. 2, the first wound area Z1 includes (1-1) a first wound portion W1 (turns T1 to T14) in which the first wire 3 is wound from the first end portion 7 toward the second end portion 8 in the first layer, (1-2) a second wound portion W2 (turns T1 to T8) in which the second wire 4 is wound to a middle of a range where the first wound portion W1 extends from the first end portion 7 toward the second end portion 8 in the second layer, (1-3) a first transfer portion R1 (turn T8→T9) in which the second wire 4 is changed in a direction from the end portion of the second wound portion W2 on the second end portion 8 side to the first end portion 7 side and is guided to the position of the third layer, (1-4) a third wound portion W3 (turns T9 to T10) in which the second wire 4 is connected to the first transfer portion R1 and is wound by N turns (here, two turns) in the third layer, (1-5) a second transfer portion R2 (turn T10→T11) in which the second wire 4 is guided from the third wound portion W3 to the position of the second layer, and (1-6) a fourth wound portion W4 (turns T11 to T14) in which the second wire 4 is connected to the second transfer portion R2 and is wound toward the second end portion 8 in the second layer.

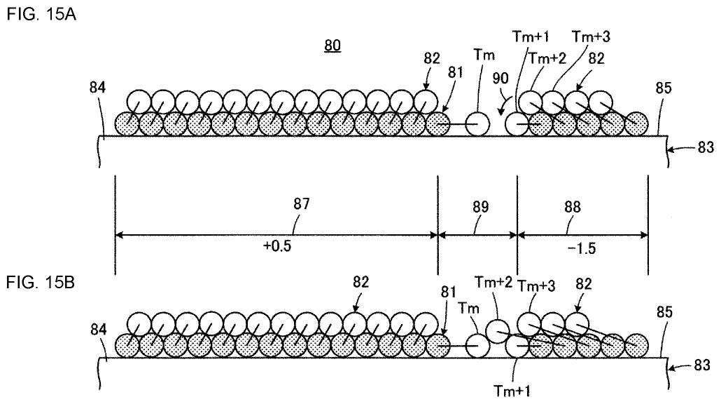

Next, the second wound area Z2 is disposed after the first wound area Z1 described above. The layer in which each of the first wire 3 and the second wire 4 is located is switched between the first wound area Z1 and the second wound area Z2. A switching portion S is shown in FIG. 3. In the switching portion S, the first wire 3 is guided to the second layer from the end portion of the first wound portion W1 on the second end portion 8 side, and the second wire 4 is guided to the first layer from the end portion of the fourth wound portion W4 on the second end portion 8 side. In the switching portion S, it is not necessary to provide a relatively wide transition area like the transition area 89 shown in FIGS. 15A and 15B. Therefore, the limited dimension of the winding core portion 5 in the axis direction 6 can be efficiently used.

Again, mainly referring to FIG. 2, the second wound area Z2 includes (2-1) a fifth wound portion W5 (turns T15 to T28) in which the second wire 4 is wound from the first end portion 7 toward the second end portion 8 in the first layer, (2-2) a sixth wound portion W6 (turns T15 to T22) in which the first wire 3 is wound to a middle of a range where the fifth wound portion W5 extends from the first end portion 7 toward the second end portion 8 in the second layer, (2-3) a third transfer portion R3 (turn T22→T23) in which the first wire 3 is changed in a direction from the end portion of the sixth wound portion W6 on the second end portion 8 side to the first end portion 7 side and is guided to the position of the third layer, (2-4) a seventh wound portion W7 (turns T23 to T24) in which the first wire 3 is connected to the third transfer portion R3 and is wound by M turns (here, two turns) in the third layer, (2-5) a fourth transfer portion R4 (turn T24→T25) in which the first wire 3 is guided from the seventh wound portion W7 to the position of the second layer, and (2-6) an eighth wound portion W8 (turns T25 to T28) in which the first wire 3 is connected to the fourth transfer portion R4 and is wound toward the second end portion 8 in the second layer.

According to the above configuration, in the first wound area Z1, since the second wire 4 located in the second layer where there is a concern about inadvertent stepping forms the first transfer portion R1 changed in the direction from the end portion of the second wound portion W2 on the second end portion 8 side to the first end portion 7 side and is guided to the position of the third layer, and the third wound portion W3 connected to the first transfer portion R1 and is wound on the third layer, it is possible to make a positional shift of the second wire 4 located in the second layer be unlikely to occur.

In addition, in the second wound area Z2, since the first wire 3 located in the second layer where there is a concern about inadvertent stepping forms the third transfer portion R3 changed in the direction from the end portion of the sixth wound portion W6 on the second end portion 8 side to the first end portion 7 side and is guided to the position of the third layer, and the seventh wound portion W7 connected to the third transfer portion R3 and is wound on the third layer, it is possible to make a positional shift of the first wire 3 located in the second layer be unlikely to occur.

In addition, in the first wound area Z1, a +0.5 turn shift area F1 in which a turn is shifted in the positive direction by 0.5 turns between the first wire 3 and the second wire 4 is present, on one of the first end portion 7 side and the second end portion 8 side of the boundary between the second wound portion W2 and the fourth wound portion W4 (the boundary between the turn T8 and the turn T11 of the wire located in the second layer, hereinafter referred to as “turn T8/T11”), in this embodiment, on the first end portion 7 side.

On the other hand, in the first wound area Z1, a −(N−0.5) turn shift area, specifically, a −1.5 turn shift area F2 in which a turn is shifted in the negative direction by (N−0.5) turns between the first wire 3 and the second wire 4 is present, on the other of the first end portion 7 side and the second end portion 8 side of the boundary (turn T8/T11) between the second wound portion W2 and the fourth wound portion W4, in this embodiment, on the second end portion 8 side.

Similarly, in the second wound area Z2, a −0.5 turn shift area F3 in which a turn is shifted in the negative direction by 0.5 turns between the first wire 3 and the second wire 4 is present, on one of the first end portion 7 side and the second end portion 8 side of the boundary between the sixth wound portion W6 and the eighth wound portion W8 (turn T22/T25), in this embodiment, on the first end portion 7 side.

On the other hand, a +(M−0.5) turn shift area, specifically, a +1.5 turn shift area F4 in which a turn is shifted in the positive direction by (M−0.5) turns between the first wire 3 and the second wire 4 is present, on the other of the first end portion 7 side and the second end portion 8 side of the boundary (turn T22/T25) between the sixth wound portion W6 and the eighth wound portion W8, in this embodiment, on the second end portion 8 side.

As described above, since the number of turns (eight turns) in the +0.5 turn shift area F1 is the same as the number of turns (eight turns) in the −0.5 turn shift area F3, and the number of turns (four turns) in the −1.5 turn shift area F2 is the same as the number of turns (four turns) in the +1.5 turn shift area F4, the capacitance is balanced between the first wound area Z1 and the second wound area Z2.

In addition, in the case of this embodiment, in the first wound area Z1, since (the number of turns in the second wound portion W2 that assigns the +0.5 turn shift area F1):(the number of turns in the fourth wound portion W4 that assigns the −1.5 turn shift area F2) is within the range of 2 to 5:1, the capacitance is balanced even within a range of the first wound area Z1.

Similarly, in the second wound area Z2, since (the number of turns in the sixth wound portion W6 that assigns the −0.5 turn shift area F3):(the number of turns in the eighth wound portion W8 that assigns the +1.5 turn shift area F4) is within the range of 2 to 5:1, the capacitance is balanced even within a range of the second wound area Z2.

With these configurations, the influence of the stray capacitance generated between the first wire 3 and the second wire 4 can be reduced, and for example, the mode conversion characteristics of the common mode choke coil can be reduced.

Furthermore, in this embodiment, the number of turns (14 turns) of the first wound portion W1 of the first wire 3 in the first wound area Z1 and the number of turns (14 turns) of the fifth wound portion W5 of the second wire 4 in the second wound area Z2 are equal to each other. Moreover, since the wire located in the first layer and the wire located in the second layer replace the layer in which each of the first wound area Z1 and the second wound area Z2 is located, the difference between the length of the first wire 3 and the length of the second wire 4 can be eliminated or reduced. This also can contribute to, for example, reducing the mode conversion characteristics in the common mode choke coil.

In addition, in the third wound portion W3 of the first wound area Z1, since the second wire 4 is wound to constitute the third layer, and in the seventh wound portion W7 of the second wound area Z2, the first wire 3 is wound to constitute the third layer, a space for winding the wire on the peripheral surface of the winding core portion 5 can be saved.

In this embodiment, as well shown in FIG. 3, the portions where the first wire 3 and the second wire 4 intersect, such as the transfer portions R1 to R4 and the switching portion S, are located along a surface other than the lower surface 29 and the top surface 30 of the winding core portion 5, specifically, along the first side surface 31. By disposing the portion in which the first wire 3 and the second wire 4 intersect in this manner, the following advantages are exhibited.

At the portion in which the first wire 3 and the second wire 4 intersect, at least two wires 3 and 4 are disposed in a direction orthogonal to the peripheral surface of the winding core portion 5, and the degree of swelling from the peripheral surface of the winding core portion 5 is relatively large. When the portion having such a large degree of swelling is located along the lower surface 29 of the winding core portion 5, the wires 3 and 4 may come into contact with or be significantly close to the mounting substrate, causing electric inconvenience. In addition, when the portion having a large degree of swelling is located along the top surface 30 of the winding core portion 5, the wires 3 and 4 may come into contact with the top plate 27 or be crushed by the top plate 27.

On the other hand, when the portion in which the degree of swelling is increased is located along a surface other than the lower surface 29 and the top surface 30 of the winding core portion 5, specifically, along the first side surface 31 or the second side surface 32, it is possible to avoid the inconvenience described above. The reason why the surface on which the portion in which the degree of swelling is increased is used to a surface other than the lower surface 29 and the top surface 30 of the winding core portion 5 is that since the cross section of the winding core portion may have a shape other than a quadrangle shape, for example, a polygonal shape such as a hexagonal shape, a circular shape, or an elliptical shape, there is a possibility that the “side surface” cannot be specified in that case.

### Other Embodiments

Hereinafter, a second to a twelfth embodiments of the present disclosure will be described with reference to FIGS. 4 to 14. In FIGS. 4 to 14, elements corresponding to the elements shown in FIG. 2 are given the same reference numerals. The same effect as that of the first embodiment described above is obtained in the second to twelfth embodiments.

### Second Embodiment

In the second embodiment shown in FIG. 4, three wound areas including a first wound area Z1, a second wound area Z2, and a third wound area Z3 are disposed in order along the axis direction 6 of the winding core portion 5.

The first wound area Z1 includes (1-1) a first wound portion W1 (turns T1 to T8) in which the first wire 3 is wound from the first end portion 7 toward the second end portion 8 in the first layer, (1-2) a second wound portion W2 (turns T1 to T4) in which the second wire 4 is wound to a middle of a range where the first wound portion W1 extends from the first end portion 7 toward the second end portion 8 in the second layer, (1-3) a first transfer portion R1 (turn T4→T5) in which the second wire 4 is changed in a direction from the end portion of the second wound portion W2 on the second end portion 8 side to the first end portion 7 side and is guided to the position of the third layer, (1-4) a third wound portion W3 (turns T5 to T6) in which the second wire 4 is connected to the first transfer portion R1 and is wound by N turns (here, two turns) in the third layer, (1-5) a second transfer portion R2 (turn T6→T7) in which the second wire 4 is guided from the third wound portion W3 to the position of the second layer, and (1-6) a fourth wound portion W4 (turns T7 to T8) in which the second wire 4 is connected to the second transfer portion R2 and is wound toward the second end portion 8 in the second layer.

Next, the second wound area Z2 is disposed after the first wound area Z1 described above. The layer in which each of the first wire 3 and the second wire 4 is located is replaced between the first wound area Z1 and the second wound area Z2. At the switching portion, the first wire 3 is guided from the end portion of the first wound portion W1 on the second end portion 8 side to the second layer, and the second wire 4 is guided from the end portion of the fourth wound portion W4 on the second end portion 8 side to the first layer.

The second wound area Z2 includes (2-1) a fifth wound portion W5 (turns T9 to T19) in which the second wire 4 is wound from the first end portion 7 toward the second end portion 8 in the first layer, (2-2) a sixth wound portion W6 (turns T9 to T14) in which the first wire 3 is wound to a middle of a range where the fifth wound portion W5 extends from the first end portion 7 toward the second end portion 8 in the second layer, (2-3) a third transfer portion R3 (turn T14→T15) in which the first wire 3 is changed in a direction from the end portion of the sixth wound portion W6 on the second end portion 8 side to the first end portion 7 side and is guided to the position of the third layer, (2-4) a seventh wound portion W7 (turns T15 to T16) in which the first wire 3 is connected to the third transfer portion R3 and is wound by M turns (here, two turns) in the third layer, (2-5) a fourth transfer portion R4 (turn T16→T17) in which the first wire 3 is guided from the seventh wound portion W7 to the position of the second layer, and (2-6) an eighth wound portion W8 (turns T17 to T19) in which the first wire 3 is connected to the fourth transfer portion R4 and is wound toward the second end portion 8 in the second layer.

Next, a third wound area Z3 is disposed after the second wound area Z2 described above. The layer in which each of the first wire 3 and the second wire 4 is located is replaced between the second wound area Z2 and the third wound area Z3. At the switching portion, the first wire 3 is guided from the end portion of the eighth wound portion W8 on the second end portion 8 side to the first layer, and the second wire 3 is guided from the end portion of the fifth wound portion W5 on the second end portion 8 side to the second layer.

The third wound area Z3 has substantially the same configuration as that of the first wound area Z1, and includes (3-1) a ninth wound portion W9 (turns T20 to T27) in which the first wire 3 is wound from the first end portion 7 toward the second end portion 8 in the first layer, (3-2) a tenth wound portion W10 (turns T20 to T23) in which the second wire 4 is wound to a middle of a range where the ninth wound portion W9 extends from the first end portion 7 toward the second end portion 8 in the second layer, (3-3) a fifth transfer portion R5 (turn T23→T24) in which the second wire 4 is changed in a direction from the end portion of the tenth wound portion W10 on the second end portion 8 side to the first end portion 7 side and is guided to the position of the third layer, (3-4) an eleventh wound portion W11 (turns T24 to T25) in which the second wire 4 is connected to the fifth transfer portion R5 and is wound by P turns (P is a natural number, here, two turns) in the third layer, (3-5) a sixth transfer portion R6 (turn T25→T26) in which the second wire 4 is guided from the end portion of the eleventh wound portion W11 on the second end portion 8 side to the position of the second layer, and (3-6) a twelfth wound portion W12 (turns T26 to T27) in which the second wire 4 is connected to the sixth transfer portion R6 and is wound toward the second end portion 8 in the second layer.

According to the second embodiment, it is possible to make a positional shift of the wire located in the second layer be unlikely to occur.

In addition, in the first wound area Z1, a +0.5 turn shift area F1 in which a turn is shifted by 0.5 turns in the positive direction between the first wire 3 and the second wire 4 is present, on the first end portion 7 side of the boundary (turn T4/T7) between the second wound portion W2 and the fourth wound portion W4.

On the other hand, in the first wound area Z1, a −(N−0.5) turn shift area, specifically, a −1.5 turn shift area F2, in which a turn is shifted by (N−0.5) turns in the negative direction between the first wire 3 and the second wire 4 is present, on the second end portion 8 side of the boundary (turn T4/T7) between the second wound portion W2 and the fourth wound portion W4.

Similarly, in the second wound area Z2, a −0.5 turn shift area F3 in which a turn is shifted by 0.5 turns in the negative direction between the first wire 3 and the second wire 4 is present, on the first end portion 7 side of the boundary (turn T14/T17) between the sixth wound portion W6 and the eighth wound portion W8.

On the other hand, in the second wound area Z2, a +(M−0.5) turn shift area, specifically, a +1.5 turn shift area F4, in which a turn is shifted by (M−0.5) turns in the positive direction between the first wire 3 and the second wire 4 is present, on the second end portion 8 side of the boundary (turn T14/T17) between the sixth wound portion W6 and the eighth wound portion W8.

Similarly, in the third wound area Z3, a +0.5 turn shift area F1 in which a turn is shifted by 0.5 turns in the positive direction between the first wire 3 and the second wire 4 is present, on the first end portion 7 side of the boundary (turn T23/T26) between the tenth wound portion W10 and the twelfth wound portion W12.

On the other hand, in the third wound area Z3, a −(P−0.5) turn shift area, specifically, a −1.5 turn shift area F2, in which a turn is shifted by (P−0.5) turns in the negative direction between the first wire 3 and the second wire 4 is present, on the second end portion 8 side of the boundary (turn T23/T26) between the ninth wound portion W9 and the twelfth wound portion W12.

In the first to third wound areas Z1 to Z3 described above, since (the number of turns in W2):(the number of turns in W4)=(the number of turns in W6):(the number of turns in W8)=(the number of turns in W10):(the number of turns in W12)=2:1 (N:1, M:1, P:1), the stray capacitance is balanced in each of the first to third wound areas Z1 to Z3.

In addition, although the total number of turns in the +0.5 turn shift area F1 and the total number of turns in the −0.5 turn shift area F3 do not match each other, and the total number of turns in the −1.5 turn shift area F2 and the total number of turns in the +1.5 turn shift area F4 do not match each other, as described above, since the ratio of the number of turns is 2:1, the stray capacitance is balanced as a whole.

The ratio of the number of turns is not limited to the case of 2:1, but when the ratio is within the range of 2 to 5:1, the stray capacitance can be balanced as a whole.

With these configurations, the influence of the stray capacitance generated between the first wire 3 and the second wire 4 can be reduced, and for example, the mode conversion characteristics of the common mode choke coil can be reduced.

In addition, the first wire 3 is the first layer in the first wound area Z1 and the third wound area Z3, and the second wire 4 is the first layer in the second wound area Z2. As described above, since the layer in which each of the first wire 3 and the second wire 4 is located is replaced between the first wound area Z1, the third wound area Z3, and the second wound area Z2, the difference between the length of the first wire 3 and the length of the second wire 4 can be reduced. This also can contribute to, for example, reducing the mode conversion characteristics in the common mode choke coil.

In the second embodiment, strictly speaking, {(the number of turns in W1)+(the number of turns in W9)} and (the number of turns in W5) are not equal to each other. Therefore, the difference between the length of the first wire 3 and the length of the second wire 4 is slightly larger than that in the first embodiment, but even in the second embodiment, the effect of reducing the mode conversion characteristics can be sufficiently exhibited in the common mode choke coil.

The arrangement of the wound areas along the winding core portion 5 may be further repeated.

### Third Embodiment

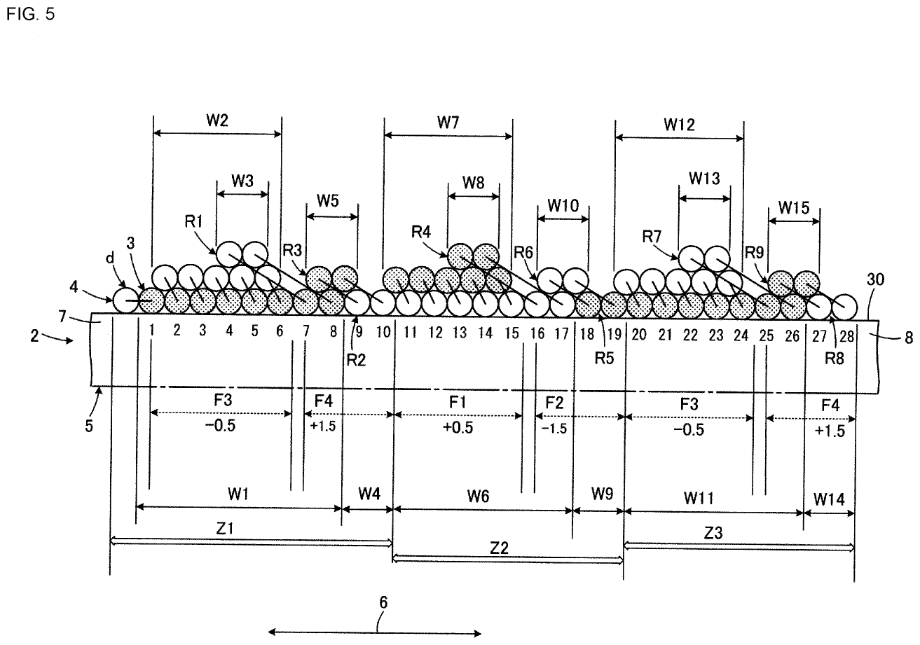

In the third embodiment shown in FIG. 5, three wound areas including a first wound area Z1, a second wound area Z2, and a third wound area Z3 are disposed in order along the axis direction 6 of the winding core portion 5.

The first wound area Z1 includes (1-1) a first wound portion W1 (turns T1 to T8) in which the first wire 3 is wound from the first end portion 7 toward the second end portion 8 in the first layer, (1-1a) an intentionally stepped portion d (turn T1) in which the second wire 4 to be located in the second layer is intentionally wound in the first layer adjacent to the end portion of the first wound portion W1 on the first end portion 7 side, (1-2) a second wound portion W2 (turns T2 to T6) in which the second wire 4 is wound to a middle of a range where the first wound portion W1 extends from the first end portion 7 toward the second end portion 8 in the second layer, (1-3) a first transfer portion R1 (turn T6→T7) in which the second wire 4 is changed in a direction from the end portion of the second wound portion W2 on the second end portion 8 side to the first end portion 7 side and is guided to the position of the third layer, (1-4) a third wound portion W3 (turns T7 to T8) in which the second wire 4 is connected to the first transfer portion R1 and is wound by N turns (here, two turns) in the third layer, (1-5) a second transfer portion R2 (turn T8-T9) in which the second wire 4 is guided from the end portion of the third wound portion W3 on the second end portion 8 side to the position of the first layer on the second end portion 8 side than the end portion of the first wound portion W1 on the second end portion 8 side, (1-6) a fourth wound portion W4 (turns T9 to T10) in which the second wire 4 is connected to the second transfer portion R2 and is wound toward the second end portion 8 in the first layer, (1-7) a third transfer portion R3 (turn T8→T9) in which the first wire 3 is changed in a direction from the end portion of the first wound portion W1 on the second end portion 8 side to the first end portion 7 side and is guided to the position of the second layer on the first wound portion W1, and (1-8) a fifth wound portion W5 (turn T9 to T10) in which the first wire 3 is connected to the third transfer portion R3 and is wound toward the second end portion 8 on the fourth wound portion W4 in the second layer.

Next, the second wound area Z2 is disposed after the first wound area Z1 described above. The layer in which each of the first wire 3 and the second wire 4 is located is replaced between the first wound area Z1 and the second wound area Z2.

The second wound area Z2 includes (2-1) a sixth wound portion W6 (turns T11 to T17) in which the second wire 4 is wound from the first end portion 7 toward the second end portion 8 in the first layer, (2-2) a seventh wound portion W7 (turns T11 to T15) in which the first wire 3 is wound to a middle of a range where the sixth wound portion W6 extends from the first end portion 7 toward the second end portion 8 in the second layer, (2-3) a fourth transfer portion R4 (turn T15→T16) in which the first wire 3 is changed in a direction from the end portion of the seventh wound portion W7 on the second end portion 8 side to the first end portion 7 side and is guided to the position of the third layer, (2-4) an eighth wound portion W8 (turns T16 to T17) in which the first wire 3 is connected to the fourth transfer portion R4 and is wound by M turns (here, two turns) in the third layer, (2-5) a fifth transfer portion R5 (turn T17→T18) in which the first wire 3 is guided from the end portion of the eighth wound portion W8 on the second end portion 8 side to the position of the first layer on the second end portion 8 side than the end portion of the sixth wound portion W6 on the second end portion 8 side, (2-6) a ninth wound portion W9 (turns T18 to T19) in which the first wire 3 is connected to the fifth transfer portion R5 and is wound toward the second end portion 8 in the first layer, (2-7) a sixth transfer portion R6 (turn T17→T18) in which the second wire 4 is changed in a direction from the end portion of the sixth wound portion W6 on the second end portion 8 side to the first end portion 7 side and is guided to the position of the second layer on the sixth wound portion W6, and (2-8) a tenth wound portion W10 (turn T18 to T19) in which the second wire 4 is connected to the sixth transfer portion R6 and is wound toward the second end portion 8 on the ninth wound portion W9 in the second layer.

Next, a third wound area Z3 is disposed after the second wound area Z2 described above. The layer in which each of the first wire 3 and the second wire 4 is located is replaced between the second wound area Z2 and the third wound area Z3.

The third wound area Z3 includes (3-1) an eleventh wound portion W11 (turns T20 to T26) in which the first wire 3 is wound from the first end portion 7 toward the second end portion 8 in the first layer, (3-2) a twelfth wound portion W12 (turns T20 to T24) in which the second wire 4 is wound to a middle of a range where the ninth wound portion W9 extends from the first end portion 7 toward the second end portion 8 in the second layer, (3-3) a seventh transfer portion R7 (turn T24→T25) in which the second wire 4 is changed in a direction from the end portion of the twelfth wound portion W12 on the second end portion 8 side to the first end portion 7 side and is guided to the position of the third layer, (3-4) a thirteenth wound portion W13 (turns T25 to T26) in which the second wire 4 is connected to the seventh transfer portion R7 and is wound by P turns (here, two turns) in the third layer, (3-5) an eighth transfer portion R8 (turn T26→T27) in which the second wire 4 is guided from the end portion of the thirteenth wound portion W13 on the second end portion 8 side to the position of the first layer on the second end portion 8 side than the end portion of the eleventh wound portion W11 on the second end portion 8 side, (3-6) a fourteenth wound portion W14 (turns T27 to T28) in which the second wire 4 is connected to the eighth transfer portion R8 and is wound toward the second end portion 8 in the first layer, (3-7) a ninth transfer portion R9 (turn T26→T27) in which the first wire 3 is changed in a direction from the end portion of the eleventh wound portion W11 on the second end portion 8 side to the first end portion 7 side and is guided to the position of the second layer on the eleventh wound portion W11, and (3-8) a fifteenth wound portion W15 (turns T27 to T28) in which the first wire 3 is connected to the ninth transfer portion R9 and is wound toward the second end portion 8 on the fourteenth wound portion W14 in the second layer.

According to the third embodiment, it is possible to make a positional shift of the wire located in the second layer be unlikely to occur.

In particular, according to the third embodiment, since the intentionally stepped portion d at the start end of the winding of the second wire 4 in the first wound area Z1 is provided, it is possible to contribute to the stabilization of the winding state of the second wire 4, and make the positional shift of the second wire 4 be unlikely to occur.

A −0.5 turn shift area F3 in which a turn is shifted by 0.5 turns in the negative direction between the first wire 3 and the second wire 4 is present, on the first end portion 7 side of the boundary (turn T6/T9) between the second wound portion W2 of the second wire 4 and the fifth wound portion W5 of the first wire 3.

On the other hand, a +(N−0.5) turn shift area, specifically, a +1.5 turn shift area F4, in which a turn is shifted by (N−0.5) turns in the positive direction between the first wire 3 and the second wire 4 is present, on the second end portion 8 side of the boundary (turn T6/T9) between the second wound portion W2 of the second wire 4 and the fifth wound portion W5 of the first wire 3.

In addition, a +0.5 turn shift area F1 in which a turn is shifted by 0.5 turns in the positive direction between the first wire 3 and the second wire 4 is present, on the first end portion 7 side of the boundary (turn T15/T18) between the seventh wound portion W7 of the first wire 3 and the tenth wound portion W10 of the second wire 4.

On the other hand, a −(M−0.5) turn shift area, specifically, a −1.5 turn shift area F2, in which a turn is shifted by (M−0.5) turns in the negative direction between the first wire 3 and the second wire 4 is present, on the second end portion 8 side of the boundary (turn T15/T18) between the seventh wound portion W7 of the first wire 3 and the tenth wound portion W10 of the second wire 4.

In addition, a −0.5 turn shift area F3 in which a turn is shifted by 0.5 turns in the negative direction between the first wire 3 and the second wire 4 is present, on the first end portion 7 side of the boundary (turn T24/T27) between the twelfth wound portion W12 of the second wire 4 and the fifteenth wound portion W15 of the first wire 3.

On the other hand, a +(P−0.5) turn shift area, specifically, a +1.5 turn shift area F4, in which a turn is shifted by (P−0.5) turns in the positive direction between the first wire 3 and the second wire 4, is present on the second end portion 8 side of the boundary (turn T24/T27) between the twelfth wound portion W12 of the second wire 4 and the fifteenth wound portion W15 of the first wire 3.

With these configurations, the influence of the stray capacitance generated between the first wire 3 and the second wire 4 can be reduced, and for example, the mode conversion characteristics of the common mode choke coil can be reduced.

In this embodiment, since (the number of turns in W2):(the number of turns in W5)=(the number of turns in W7):(the number of turns in W10)=(the number of turns in W12):(the number of turns in W15)=5:2, and N:1 (M:1, P:1) is within the range of 2 to 5:1, the stray capacitance is balanced.

In addition, although the total number of turns in the −0.5 turn shift area F3 and the total number of turns in the +0.5 turn shift area F1 do not match each other, the ratio is 10:5, the total number of turns in the +1.5 turn shift area F4, and the total number of turns in the −1.5 turn shift area F2 do not match each other, and the ratio is 4:2, since both are within the range of 2 to 5:1, the stray capacitance is balanced.

Therefore, even in this embodiment, the stray capacitance is balanced, and thus an effect of reducing the mode conversion characteristics can be expected in the common mode choke coil.

In addition, in the present embodiment, since the layer in which the first wire 3 and the second wire 4 is located is replaced in the first wound area Z1, the third wound area Z3, and the second wound area Z2, the difference between the length of the first wire 3 and the length of the second wire 4 can be reduced. This can also contribute to reducing the mode conversion characteristics in the common mode choke coil.

The arrangement of the wound areas along the winding core portion 5 may be further repeated.

### Fourth Embodiment

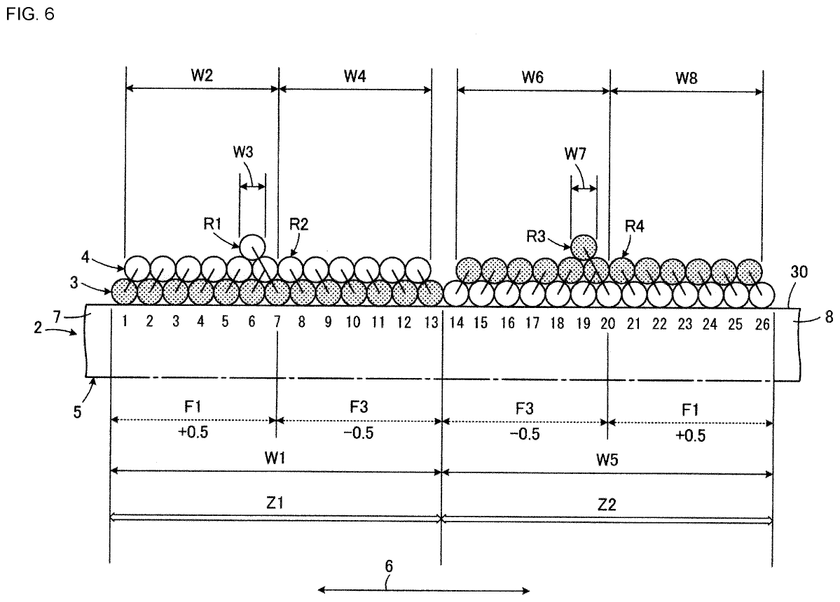

The fourth embodiment shown in FIG. 6 has two wound areas including a first wound area Z1 and a second wound area Z2 disposed in order along the axis direction 6 of the winding core portion 5, and differs in that the wire constituting the third layer has one turn (N=1, M=1), as compared with the configuration of the first embodiment.

The first wound area Z1 includes (1-1) a first wound portion W1 (turns T1 to T13) in which the first wire 3 is wound from the first end portion 7 toward the second end portion 8 in the first layer, (1-2) a second wound portion W2 (turns T1 to T6) in which the second wire 4 is wound to a middle of a range where the first wound portion W1 extends from the first end portion 7 toward the second end portion 8 in the second layer, (1-3) a first transfer portion R1 (turn T6→T7) in which the second wire 4 is changed in a direction from the end portion of the second wound portion W2 on the second end portion 8 side to the first end portion 7 side and is guided to the position of the third layer, (1-4) a third wound portion W3 (turn T7) in which the second wire 4 is connected to the first transfer portion R1 and is wound by N turns (here, one turn) in the third layer, (1-5) a second transfer portion R2 (turn T7→T8) in which the second wire 4 is guided from the third wound portion W3 to the position of the second layer, and (1-6) a fourth wound portion W4 (turns T8 to T13) in which the second wire 4 is connected to the second transfer portion R2 and is wound toward the second end portion 8 in the second layer.

Next, the second wound area Z2 is disposed after the first wound area Z1 described above. The layer in which each of the first wire 3 and the second wire 4 is located is replaced between the first wound area Z1 and the second wound area Z2. At the switching portion, the first wire 3 is guided from the end portion of the first wound portion W1 on the second end portion 8 side to the second layer, and the second wire 3 is guided from the end portion of the fourth wound portion W4 on the second end portion 8 side to the first layer.

The second wound area Z2 includes (2-1) a fifth wound portion W5 (turns T14 to T26) in which the second wire 4 is wound from the first end portion 7 toward the second end portion 8 in the first layer, (2-1) a sixth wound portion W6 (turns T14 to T19) in which the first wire 3 is wound to a middle of a range where the fifth wound portion W5 extends from the first end portion 7 toward the second end portion 8 in the second layer, (2-3) a third transfer portion R3 (turn T19→T20) in which the first wire 3 is changed in a direction from the end portion of the sixth wound portion W6 on the second end portion 8 side to the first end portion 7 side and is guided to the position of the third layer, (2-4) a seventh wound portion W7 (turn T20) in which the first wire 3 is connected to the third transfer portion R3 and is wound by M turns (here, one turn) in the third layer, (2-5) a fourth transfer portion R4 (turn T20→T21) in which the first wire 3 is guided from the seventh wound portion W7 to the position of the second layer, and (2-6) an eighth wound portion W8 (turns T21 to T26) in which the first wire 3 is connected to the fourth transfer portion R4 and is wound toward the second end portion 8 in the second layer.

According to the fourth embodiment, it is possible to make a positional shift of the wire located in the second layer be unlikely to occur.

In addition, in the first wound area Z1, a +0.5 turn shift area F1 in which a turn is shifted by 0.5 turns in the positive direction between the first wire 3 and the second wire 4 is present, on the first end portion 7 side of the boundary (turn T6/T8) between the second wound portion W2 and the fourth wound portion W4.

On the other hand, in the first wound area Z1, a −(N−0.5) turn shift area, specifically, a −0.5 turn shift area F3, in which a turn is shifted by (N−0.5) turns in the negative direction between the first wire 3 and the second wire 4, is present on the second end portion 8 side of the boundary (turn T6/T8) between the second wound portion W2 and the fourth wound portion W4.

In addition, in the second wound area Z2, a −0.5 turn shift area F3 in which a turn is shifted by 0.5 turns in the negative direction between the first wire 3 and the second wire 4 is present, on the first end portion 7 side of the boundary (turn T19/T21) between the sixth wound portion W6 and the eighth wound portion W8.

On the other hand, a +(M−0.5) turn shift area, specifically, a +0.5 turn shift area F1, in which a turn is shifted by (M−0.5) turns in the positive direction between the first wire 3 and the second wire 4, is present on the second end portion 8 side of the boundary (turn T19/T21) between the sixth wound portion W6 and the eighth wound portion W8.

With these configurations, the influence of the stray capacitance generated between the first wire 3 and the second wire 4 can be reduced, and for example, the mode conversion characteristics of the common mode choke coil can be reduced.

In this embodiment, since (the number of turns in W2):(the number of turns in W4)=(the number of turns in W6):(the number of turns in W8)=1:1 (N:1, M:1), the stray capacitance is balanced also within the range of each of the first wound area Z1 and the second wound area Z2.

In addition, in the first wound area Z1 and the second wound area Z2, since the layer in which each of the first wire 3 and the second wire 4 is located is replaced, and (the number of turns in W1):(the number of turns in W5)=1:1, the difference between the length of the first wire 3 and the length of the second wire 4 can be eliminated or reduced. These things also can contribute to, for example, reducing the mode conversion characteristics in the common mode choke coil.

### Fifth Embodiment

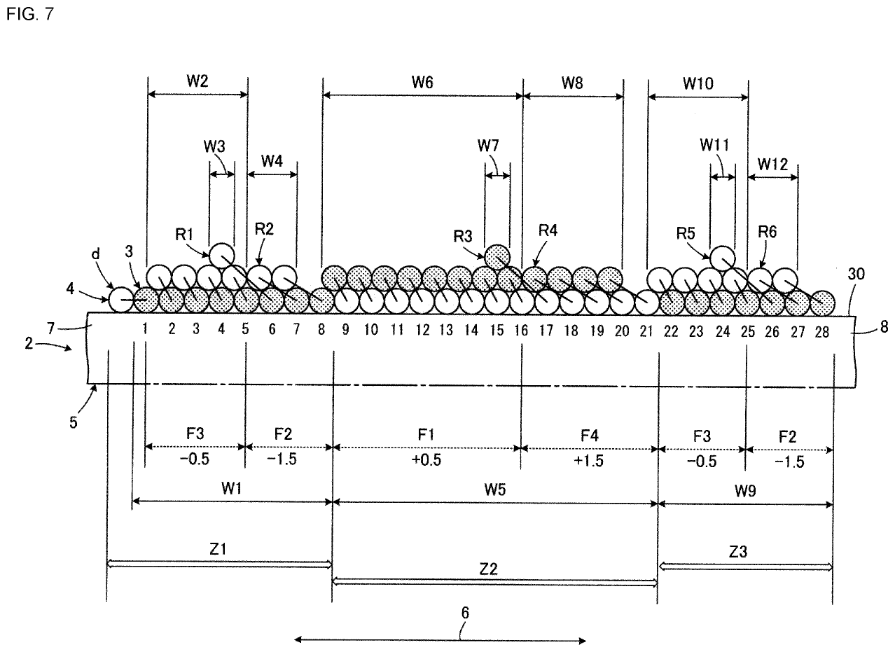

In the fifth embodiment shown in FIG. 7, three wound areas including a first wound area Z1, a second wound area Z2, and a third wound area Z3 are disposed in order along the axis direction 6 of the winding core portion 5, and the wire constituting the third layer is one turn (N=1, M=1, and P=1).

The first wound area Z1 includes (1-1) a first wound portion W1 (turns T1 to T8) in which the first wire 3 is wound from the first end portion 7 toward the second end portion 8 in the first layer, (1-1a) an intentionally stepped portion d (turn T1) in which the second wire 4 to be located in the second layer is intentionally wound in the first layer adjacent to the end portion of the first wound portion W1 on the first end portion 7 side, (1-2) a second wound portion W2 (turns T2 to T5) in which the second wire 4 is wound to a middle of a range where the first wound portion W1 extends from the first end portion 7 toward the second end portion 8 in the second layer, (1-3) a first transfer portion R1 (turn T5→T6) in which the second wire 4 is changed in a direction from the end portion of the second wound portion W2 on the second end portion 8 side to the first end portion 7 side and is guided to the position of the third layer, (1-4) a third wound portion W3 (turn T6) in which the second wire 4 is connected to the first transfer portion R1 and is wound by N turns (here, one turn) in the third layer, (1-5) a second transfer portion R2 (turn T6→T7) in which the second wire 4 is guided from the third wound portion W3 to the position of the second layer, and (1-6) a fourth wound portion W4 (turns T7 to T8) in which the second wire 4 is connected to the second transfer portion R2 and is wound toward the second end portion 8 in the second layer.

Next, the second wound area Z2 is disposed after the first wound area Z1 described above. The layer in which each of the first wire 3 and the second wire 4 is located is replaced between the first wound area Z1 and the second wound area Z2. At the switching portion, the first wire 3 is guided from the end portion of the first wound portion W1 on the second end portion 8 side to the second layer, and the second wire 4 is guided from the end portion of the fourth wound portion W4 on the second end portion 8 side to the first layer.

The second wound area Z2 includes (2-1) a fifth wound portion W5 (turns T9 to T21) in which the second wire 4 is wound from the first end portion 7 toward the second end portion 8 in the first layer, (2-2) a sixth wound portion W6 (turns T9 to T16) in which the first wire 3 is wound to a middle of a range where the fifth wound portion W5 extends from the first end portion 7 toward the second end portion 8 in the second layer, (2-3) a third transfer portion R3 (turn T16→T17) in which the first wire 3 is changed in a direction from the end portion of the sixth wound portion W6 on the second end portion 8 side to the first end portion 7 side and is guided to the position of the third layer, (2-4) a seventh wound portion W7 (turn T17) in which the first wire 3 is connected to the third transfer portion R3 and is wound by M turns (here, one turn) in the third layer, (2-5) a fourth transfer portion R4 (turn T17→T18) in which the first wire 3 is guided from the seventh wound portion W7 to the position of the second layer, and (2-6) an eighth wound portion W8 (turns T18 to T21) in which the first wire 3 is connected to the fourth transfer portion R4 and is wound toward the second end portion 8 in the second layer.

Next, a third wound area Z3 is disposed after the second wound area Z2 described above. The layer in which each of the first wire 3 and the second wire 4 is located is replaced between the second wound area Z2 and the third wound area Z3. At the switching portion, the first wire 3 is guided from the end portion of the eighth wound portion W8 on the second end portion 8 side to the first layer, and the second wire 3 is guided from the end portion of the fifth wound portion W5 on the second end portion 8 side to the second layer.

The third wound area Z3 includes (3-1) a ninth wound portion W9 (turns T22 to T28) in which the first wire 3 is wound from the first end portion 7 toward the second end portion 8 in the first layer, (3-2) a tenth wound portion W10 (turns T22 to T25) in which the second wire 4 is wound to a middle of a range where the ninth wound portion W9 extends from the first end portion 7 toward the second end portion 8 in the second layer, (3-3) a fifth transfer portion R5 (turn T25→T26) in which the second wire 4 is changed in a direction from the end portion of the tenth wound portion W10 on the second end portion 8 side to the first end portion 7 side and is guided to the position of the third layer, (3-4) an eleventh wound portion W11 (turn T26) around which the second wire 4 is connected to the fifth transfer portion R5 and is wound by P turns (here, one turn) in the third layer, (3-5) sixth transfer portion R6 (turn T26→T27) in which the second wire 4 is guided from the end portion of the eleventh wound portion W11 on the second end portion 8 side to the position of the second layer, and (3-6) a twelfth wound portion W12 (turns T27 to T28) in which the second wire 4 is connected to the sixth transfer portion R6 and is wound toward the second end portion 8 in the second layer.

According to the fifth embodiment, it is possible to make a positional shift of the wire located in the second layer be unlikely to occur.

In particular, according to the fifth embodiment, since the intentionally stepped portion d at the start end of the winding of the second wire 4 in the first wound area Z1 is provided, it is possible to contribute to the stabilization of the winding state of the second wire 4, and make the positional shift of the second wire 4 be unlikely to occur.

In the first wound area Z1, a −0.5 turn shift area F3, in which a turn is shifted by 0.5 turns in the negative direction between the first wire 3 and the second wire 4, is present on the first end portion 7 side of the boundary (turn T5/T7) between the second wound portion W2 and the fourth wound portion W4.

On the other hand, in the first wound area Z1, a −(N−0.5) turn shift area, specifically, a −1.5 turn shift area F2, in which a turn is shifted by (N−0.5) turns in the negative direction between the first wire 3 and the second wire 4 is present, on the second end portion 8 side of the boundary (turn T5/T7) between the second wound portion W2 and the fourth wound portion W4.

In addition, in the second wound area Z2, a +0.5 turn shift area F1 in which a turn is shifted by 0.5 turns in the positive direction between the first wire 3 and the second wire 4 is present, on the first end portion 7 side of the boundary (turn T16/T18) between the sixth wound portion W6 and the eighth wound portion W8.

On the other hand, in the second wound area Z2, a +(M−0.5) turn shift area, specifically, a +1.5 turn shift area F4, in which a turn is shifted by (M−0.5) turns in the positive direction between the first wire 3 and the second wire 4 is present, on the second end portion 8 side of the boundary (turn T16/T18) between the sixth wound portion W6 and the eighth wound portion W8.

In addition, in the third wound area Z3, a −0.5 turn shift area F3 in which a turn is shifted by 0.5 turns in the negative direction between the first wire 3 and the second wire 4 is present, on the first end portion 7 side of the boundary (turn T25/T27) between the tenth wound portion W10 and the twelfth wound portion W12.

On the other hand, in the third wound area Z3, a −(P−0.5) turn shift area, specifically, a −1.5 turn shift area F2, in which a turn is shifted by (P−0.5) turns in the negative direction between the first wire 3 and the second wire 4 is present, on the second end portion 8 side of the boundary (turn T25/T27) between the ninth wound portion W9 and the twelfth wound portion W12.

With these configurations, the influence of the stray capacitance generated between the first wire 3 and the second wire 4 can be reduced, and for example, the mode conversion characteristics of the common mode choke coil can be reduced.

In the present embodiment, the stray capacitance is not balanced in each of the first to third wound areas Z1 to Z3, but the stray capacitance is balanced as a whole as follows.

That is, the total number of turns in the −0.5 turn shift area F3 is the total (eight turns) of the number of turns (four turns) in W2 and the number of turns (four turns) in W10. On the other hand, the total number of turns in the +0.5 turn shift area F1 is the number of turns (eight turns) in W6. Therefore, the total number of turns in the −0.5 turn shift area F3 and the total number of turns in the +0.5 turn shift area F1 are equal to each other.

In addition, the total number of turns in the −1.5 turn shift area F2 is the total (four turns) of the number of turns (two turns) in W4 and the number of turns (two turns) in W12. On the other hand, the total number of turns in the +1.5 turn shift area F4 is the number of turns (four turns) in W8. Therefore, the total number of turns in the −1.5 turn shift area F2 and the total number of turns in the +1.5 turn shift area F4 are equal to each other.

With these configurations, the stray capacitance is balanced as a whole.

In addition, when paying attention to the number of turns of the wire 3 or 4 located in the first layer, the first wire 3 has 8 turns in W1, 7 turns in W9, and a total of 15 turns, while the second wire 4 has 13 turns in W5, and the number of turns of the first wire 3 and the number of turns of the second wire 4 are different from each other, and the length of each of the wires 3 and 4 is different. Therefore, strictly speaking, the first wire 3 and the second wire 4 are not balanced in terms of each of the lengths. However, the difference between the length of the first wire 3 and the length of the second wire 4 can be reduced as compared to a case where the layer in which each of the first wire 3 and the second wire 4 is located is not replaced. Therefore, in the present embodiment, the effect of reducing the mode conversion characteristics can be sufficiently exhibited in the common mode choke coil.

The arrangement of the wound areas along the winding core portion 5 may be further repeated.

### Sixth Embodiment

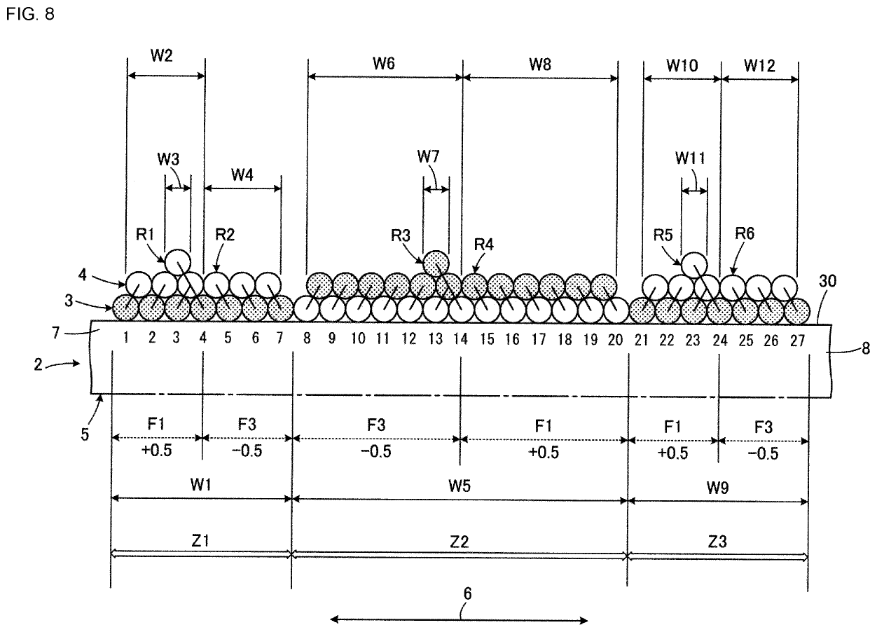

In the sixth embodiment shown in FIG. 8, similarly to the configuration of the fifth embodiment, three wound areas including a first wound area Z1, a second wound area Z2, and a third wound area Z3 are disposed in order along the axis direction 6 of the winding core portion 5, and the wire constituting the third layer is one turn (N=1, M=1, and P=1).

The first wound area Z1 includes (1-1) a first wound portion W1 (turns T1 to T7) in which the first wire 3 is wound from the first end portion 7 toward the second end portion 8 in the first layer, (1-2) a second wound portion W2 (turns T1 to T3) in which the second wire 4 is wound to a middle of a range where the first wound portion W1 extends from the first end portion 7 toward the second end portion 8 in the second layer, (1-3) a first transfer portion R1 (turn T3→T4) in which the second wire 4 is changed in a direction from the end portion of the second wound portion W2 on the second end portion 8 side to the first end portion 7 side and is guided to the position of the third layer, (1-4) a third wound portion W3 (turn T4) in which the second wire 4 is connected to the first transfer portion R1 and is wound by N turns (here, one turn) in the third layer, (1-5) a second transfer portion R2 (turn T4→T5) in which the second wire 4 is guided from the third wound portion W3 to the position of the second layer, and (1-6) a fourth wound portion W4 (turns T5 to T7) in which the second wire 4 is connected to the second transfer portion R2 and is wound toward the second end portion 8 in the second layer.

Next, the second wound area Z2 is disposed after the first wound area Z1 described above. The layer in which each of the first wire 3 and the second wire 4 is located is replaced between the first wound area Z1 and the second wound area Z2. At the switching portion, the first wire 3 is guided from the end portion of the first wound portion W1 on the second end portion 8 side to the second layer, and the second wire 3 is guided from the end portion of the fourth wound portion W4 on the second end portion 8 side to the first layer.

The second wound area Z2 includes (2-1) a fifth wound portion W5 (turns T8 to T20) in which the second wire 4 is wound from the first end portion 7 toward the second end portion 8 in the first layer, (2-2) a sixth wound portion W6 (turns T8 to T13) in which the first wire 3 is wound to a middle of a range where the fifth wound portion W5 extends from the first end portion 7 toward the second end portion 8 in the second layer, (2-3) a third transfer portion R3 (turn T13→T14) in which the first wire 3 is changed in a direction from the end portion of the sixth wound portion W6 on the second end portion 8 side to the first end portion 7 side and is guided to the position of the third layer, (2-4) a seventh wound portion W7 (turn T14) in which the first wire 3 is connected to the third transfer portion R3 and is wound by M turns (here, one turn) in the third layer, (2-5) a fourth transfer portion R4 (turn T14→T15) in which the first wire 3 is guided from the seventh wound portion W7 to the position of the second layer, and (2-6) an eighth wound portion W8 (turns T15 to T20) in which the first wire 3 is connected to the fourth transfer portion R4 and is wound toward the second end portion 8 in the second layer.

Next, a third wound area Z3 is disposed after the second wound area Z2 described above. The layer in which each of the first wire 3 and the second wire 4 is located is replaced between the second wound area Z2 and the third wound area Z3. At the switching portion, the first wire 3 is guided from the end portion of the eighth wound portion W8 on the second end portion 8 side to the first layer, and the second wire 3 is guided from the end portion of the fifth wound portion W5 on the second end portion 8 side to the second layer.

The third wound area Z3 includes (3-1) a ninth wound portion W9 (turns T21 to T27) in which the first wire 3 is wound from the first end portion 7 toward the second end portion 8 in the first layer, (3-2) a tenth wound portion W10 (turns T21 to T23) in which the second wire 4 is wound to a middle of a range where the ninth wound portion W9 extends from the first end portion 7 toward the second end portion 8 in the second layer, (3-3) a fifth transfer portion R5 (turn T23→T24) in which the second wire 4 is changed in a direction from the end portion of the tenth wound portion W10 on the second end portion 8 side to the first end portion 7 side and is guided to the position of the third layer, (3-4) an eleventh wound portion W11 (turn T24) in which the second wire 4 is connected to the fifth transfer portion R5 and is wound by P turns (here, one turn) in the third layer, (3-5) a sixth transfer portion R6 (turn T24→T25) in which the second wire 4 is guided from the end portion of the eleventh wound portion W11 on the second end portion 8 side to the position of the second layer, and (3-6) a twelfth wound portion W12 (turns T25 to T27) in which the second wire 4 is connected to the sixth transfer portion R6 and is wound toward the second end portion 8 in the second layer.

According to the sixth embodiment, it is possible to make a positional shift of the wire located in the second layer be unlikely to occur.

In addition, in the first wound area Z1, a +0.5 turn shift area F1 in which a turn is shifted by 0.5 turns in the positive direction between the first wire 3 and the second wire 4 is present, on the first end portion 7 side of the boundary (turn T3/T5) between the second wound portion W2 and the fourth wound portion W4.

On the other hand, in the first wound area Z1, a −(N−0.5) turn shift area, specifically, a −0.5 turn shift area F3, in which a turn is shifted by (N−0.5) turns in the negative direction between the first wire 3 and the second wire 4, is present on the second end portion 8 side of the boundary (turn T3/T5) between the second wound portion W2 and the fourth wound portion W4.

In addition, in the second wound area Z2, a −0.5 turn shift area F3 in which a turn is shifted by 0.5 turns in the negative direction between the first wire 3 and the second wire 4 is present, on the first end portion 7 side of the boundary (turn T13/T15) between the sixth wound portion W6 and the eighth wound portion W8.

On the other hand, in the second wound area Z2, a +(M−0.5) turn shift area, specifically, a +0.5 turn shift area F1, in which a turn is shifted by (M−0.5) turns in the positive direction between the first wire 3 and the second wire 4, is present on the second end portion 8 side of the boundary (turn T13/T15) between the sixth wound portion W6 and the eighth wound portion W8.

In addition, in the third wound area Z3, a +0.5 turn shift area F1 in which a turn is shifted by 0.5 turns in the positive direction between the first wire 3 and the second wire 4 is present, on the first end portion 7 side of the boundary (turn T23/T25) between the tenth wound portion W10 and the twelfth wound portion W12.

On the other hand, in the third wound area Z3, a −(P−0.5) turn shift area, specifically, a −0.5 turn shift area F3, in which a turn is shifted by (P−0.5) turns in the negative direction between the first wire 3 and the second wire 4, is present on the second end portion 8 side of the boundary (turn T23/T25) between the ninth wound portion W9 and the twelfth wound portion W12.

With these configurations, the influence of the stray capacitance generated between the first wire 3 and the second wire 4 can be reduced, and for example, the mode conversion characteristics of the common mode choke coil can be reduced.

In addition, in the present embodiment, since the layer in which the first wire 3 and the second wire 4 is located is replaced in the first wound area Z1, the third wound area Z3, and the second wound area Z2, the difference between the length of the first wire 3 and the length of the second wire 4 can be reduced. This can also contribute to reducing the mode conversion characteristics in the common mode choke coil.

The arrangement of the wound areas along the winding core portion 5 may be further repeated.

### Seventh Embodiment

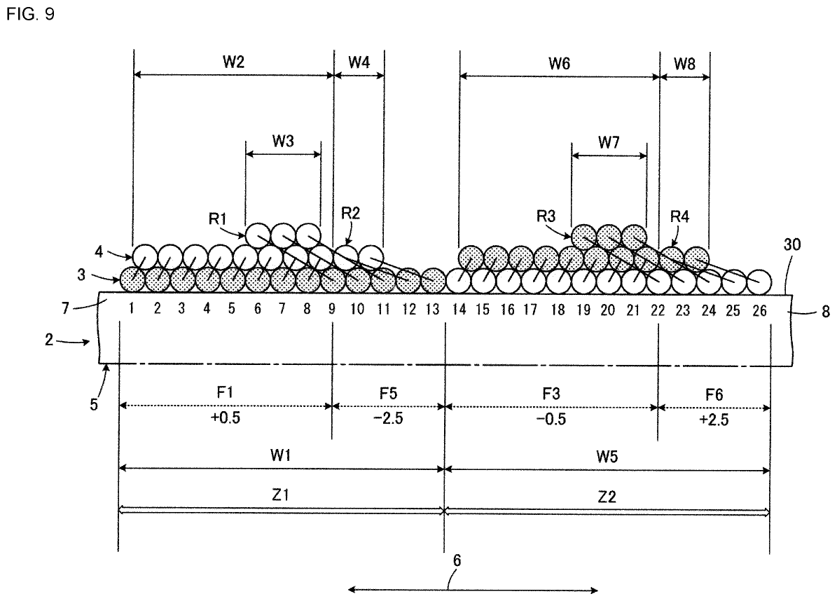

The seventh embodiment shown in FIG. 9 has two wound areas including a first wound area Z1 and a second wound area Z2 disposed in order along the axis direction 6 of the winding core portion 5, and for example, differs in that the wire constituting the third layer has three turns (N=3, M=3), as compared with the configuration of the first or fourth embodiment.

The first wound area Z1 includes (1-1) a first wound portion W1 (turns T1 to T13) in which the first wire 3 is wound from the first end portion 7 toward the second end portion 8 in the first layer, (1-2) a second wound portion W2 (turns T1 to T8) in which the second wire 4 is wound to a middle of a range where the first wound portion W1 extends from the first end portion 7 toward the second end portion 8 in the second layer, (1-3) a first transfer portion R1 (turn T8→T9) in which the second wire 4 is changed in a direction from the end portion of the second wound portion W2 on the second end portion 8 side to the first end portion 7 side and is guided to the position of the third layer, (1-4) a third wound portion W3 (turns T9 to T11) in which the second wire 4 is connected to the first transfer portion R1 and is wound by N turns (here, three turns) in the third layer, (1-5) a second transfer portion R2 (turn T11→T12) in which the second wire 4 is guided from the third wound portion W3 to the position of the second layer, and (1-6) a fourth wound portion W4 (turns T12 to T13) in which the second wire 4 is connected to the second transfer portion R2 and is wound toward the second end portion 8 in the second layer.

Next, the second wound area Z2 is disposed after the first wound area Z1 described above. The layer in which each of the first wire 3 and the second wire 4 is located is replaced between the first wound area Z1 and the second wound area Z2. At the switching portion, the first wire 3 is guided from the end portion of the first wound portion W1 on the second end portion 8 side to the second layer, and the second wire 3 is guided from the end portion of the fourth wound portion W4 on the second end portion 8 side to the first layer.

The second wound area Z2 includes (2-1) a fifth wound portion W5 (turns T14 to T26) in which the second wire 4 is wound from the first end portion 7 toward the second end portion 8 in the first layer, (2-1) a sixth wound portion W6 (turns T14 to T21) in which the first wire 3 is wound to a middle of a range where the fifth wound portion W5 extends from the first end portion 7 toward the second end portion 8 in the second layer, (2-3) a third transfer portion R3 (turn T21→T22) in which the first wire 3 is changed in a direction from the end portion of the sixth wound portion W6 on the second end portion 8 side to the first end portion 7 side and is guided to the position of the third layer, (2-4) a seventh wound portion W7 (turns T22 to T24) in which the first wire 3 is connected to the third transfer portion R3 and is wound by M turns (here, three turns) in the third layer, (2-5) a fourth transfer portion R4 (turn T24→T25) in which the first wire 3 is guided from the seventh wound portion W7 to the position of the second layer, and (2-6) an eighth wound portion W8 (turns T25 to T26) in which the first wire 3 is connected to the fourth transfer portion R4 and is wound toward the second end portion 8 in the second layer.

According to the seventh embodiment, it is possible to make a positional shift of the wire located in the second layer be unlikely to occur.

In addition, in the first wound area Z1, a +0.5 turn shift area F1 in which a turn is shifted by 0.5 turns in the positive direction between the first wire 3 and the second wire 4 is present, on the first end portion 7 side of the boundary (turn T8/T11) between the second wound portion W2 and the fourth wound portion W4.

On the other hand, in the first wound area Z1, a −(N−0.5) turn shift area, specifically, a −2.5 turn shift area F5, in which a turn is shifted by (N−0.5) turns in the negative direction between the first wire 3 and the second wire 4, is present on the second end portion 8 side of the boundary (turn T8/T11) between the second wound portion W2 and the fourth wound portion W4.

In addition, in the second wound area Z2, a −0.5 turn shift area F3 in which a turn is shifted by 0.5 turns in the negative direction between the first wire 3 and the second wire 4 is present, on the first end portion 7 side of the boundary (turn T21/T24) between the sixth wound portion W6 and the eighth wound portion W8.

On the other hand, a +(M−0.5) turn shift area, specifically, a +2.5 turn shift area F6, in which a turn is shifted by (M−0.5) turns in the positive direction between the first wire 3 and the second wire 4, is present on the second end portion 8 side of the boundary (turn T21/T24) between the sixth wound portion W6 and the eighth wound portion W8.

With these configurations, the influence of the stray capacitance generated between the first wire 3 and the second wire 4 can be reduced, and for example, the mode conversion characteristics of the common mode choke coil can be reduced.

In the present embodiment, the number of turns in the +0.5 turn shift area F1 and the number of turns in the −0.5 turn shift area F3 are both 8 turns and are equal to each other. In addition, the number of turns in the −2.5 turn shift area F5 and the number of turns in the +2.5 turn shift area F6 are both 2 turns and are equal to each other. Therefore, the stray capacitance is balanced as a whole.

On the other hand, when paying attention to the balance of the stray capacitance in each of the first wound area Z1 and the second wound area Z2, in the first wound area Z1, (the number of turns in the +0.5 turn shift area F1):(the number of turns in the −2.5 turn shift area F5) is 4:1. Since the ratio is within the range of 2 to 5:1, the stray capacitance is balanced. In addition, in the second wound area Z2, (the number of turns in −0.5 turn shift area F3):(the number of turns in +2.5 turn shift area F6) is 4:1. Since the ratio is also within the range of 2 to 5:1, the stray capacitance is balanced.

In addition, in the present embodiment, since the layer in which each of the first wire 3 and the second wire 4 is located is replaced in the first wound area Z1 and the second wound area Z2, the difference between the length of the first wire 3 and the length of the second wire 4 can be reduced. This can also contribute to reducing the mode conversion characteristics in the common mode choke coil.

### Eighth Embodiment

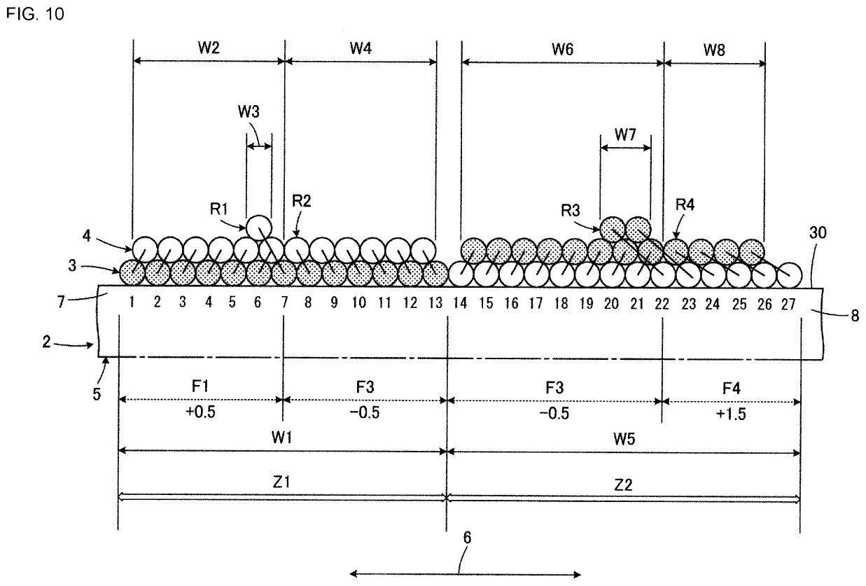

In the eighth embodiment shown in FIG. 10, two wound areas including a first wound area Z1 and a second wound area Z2 are disposed in order along the axis direction 6 of the winding core portion 5, and the number of turns of the wire constituting the third layers is different between the first wound area Z1 and the second wound area Z2.

The first wound area Z1 includes (1-1) a first wound portion W1 (turns T1 to T13) in which the first wire 3 is wound from the first end portion 7 toward the second end portion 8 in the first layer, (1-2) a second wound portion W2 (turns T1 to T6) in which the second wire 4 is wound to a middle of a range where the first wound portion W1 extends from the first end portion 7 toward the second end portion 8 in the second layer, (1-3) a first transfer portion R1 (turn T6→T7) in which the second wire 4 is changed in a direction from the end portion of the second wound portion W2 on the second end portion 8 side to the first end portion 7 side and is guided to the position of the third layer, (1-4) a third wound portion W3 (turn T7) in which the second wire 4 is connected to the first transfer portion R1 and is wound by N turns (here, one turn) in the third layer, (1-5) a second transfer portion R2 (turn T7→T8) in which the second wire 4 is guided from the third wound portion W3 to the position of the second layer, and (1-6) a fourth wound portion W4 (turns T8 to T13) in which the second wire 4 is connected to the second transfer portion R2 and is wound toward the second end portion 8 in the second layer.

Next, the second wound area Z2 is disposed after the first wound area Z1 described above. The layer in which each of the first wire 3 and the second wire 4 is located is replaced between the first wound area Z1 and the second wound area Z2. At the switching portion, the first wire 3 is guided from the end portion of the first wound portion W1 on the second end portion 8 side to the second layer, and the second wire 3 is guided from the end portion of the fourth wound portion W4 on the second end portion 8 side to the first layer.

The second wound area Z2 includes (2-1) a fifth wound portion W5 (turns T14 to T27) in which the second wire 4 is wound from the first end portion 7 toward the second end portion 8 in the first layer, (2-1) a sixth wound portion W6 (turns T14 to T21) in which the first wire 3 is wound to a middle of a range where the fifth wound portion W5 extends from the first end portion 7 toward the second end portion 8 in the second layer, (2-3) a third transfer portion R3 (turn T21→T22) in which the first wire 3 is changed in a direction from the end portion of the sixth wound portion W6 on the second end portion 8 side to the first end portion 7 side and is guided to the position of the third layer, (2-4) a seventh wound portion W7 (turns T22 to T23) in which the first wire 3 is connected to the third transfer portion R3 and is wound by M turns (here, two turns) in the third layer, (2-5) a fourth transfer portion R4 (turn T23→T24) in which the first wire 3 is guided from the seventh wound portion W7 to the position of the second layer, and (2-6) an eighth wound portion W8 (turns T24 to T27) in which the first wire 3 is connected to the fourth transfer portion R4 and is wound toward the second end portion 8 in the second layer.

According to the eighth embodiment, it is possible to make a positional shift of the wire located in the second layer be unlikely to occur.

In addition, in the first wound area Z1, a +0.5 turn shift area F1 in which a turn is shifted by 0.5 turns in the positive direction between the first wire 3 and the second wire 4 is present, on the first end portion 7 side of the boundary (turn T6/T8) between the second wound portion W2 and the fourth wound portion W4.

On the other hand, in the first wound area Z1, a −(N−0.5) turn shift area, specifically, a −0.5 turn shift area F3, in which a turn is shifted by (N−0.5) turns in the negative direction between the first wire 3 and the second wire 4, is present on the second end portion 8 side of the boundary (turn T6/T8) between the second wound portion W2 and the fourth wound portion W4.

In addition, in the second wound area Z2, a −0.5 turn shift area F3 in which a turn is shifted by 0.5 turns in the negative direction between the first wire 3 and the second wire 4 is present, on the first end portion 7 side of the boundary (turn T21/T24) between the sixth wound portion W6 and the eighth wound portion W8.

On the other hand, a +(M−0.5) turn shift area, specifically, a +1.5 turn shift area F4, in which a turn is shifted by (M−0.5) turns in the positive direction between the first wire 3 and the second wire 4 is present, on the second end portion 8 side of the boundary (turn T21/T24) between the sixth wound portion W6 and the eighth wound portion W8.

With these configurations, the influence of the stray capacitance generated between the first wire 3 and the second wire 4 can be reduced, and for example, the mode conversion characteristics of the common mode choke coil can be reduced.

In addition, in the present embodiment, since the layer in which each of the first wire 3 and the second wire 4 is located is replaced in the first wound area Z1 and the second wound area Z2, the difference between the length of the first wire 3 and the length of the second wire 4 can be reduced. This can also contribute to reducing the mode conversion characteristics in the common mode choke coil.

### Ninth Embodiment

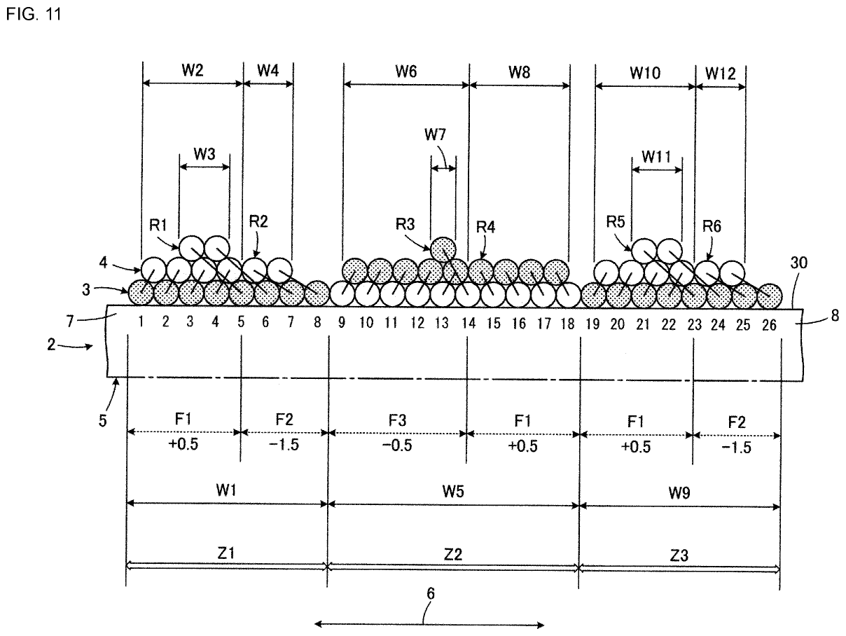

In the ninth embodiment shown in FIG. 11, three wound areas including a first wound area Z1, a second wound area Z2, and a third wound area Z3 are disposed in order along the axis direction 6 of the winding core portion 5, and the number of turns of the wire constituting the third layer differs among the first wound area Z1, the third wound area Z3, and the second wound area Z2.

The first wound area Z1 includes (1-1) a first wound portion W1 (turns T1 to T8) in which the first wire 3 is wound from the first end portion 7 toward the second end portion 8 in the first layer, (1-2) a second wound portion W2 (turns T1 to T4) in which the second wire 4 is wound to a middle of a range where the first wound portion W1 extends from the first end portion 7 toward the second end portion 8 in the second layer, (1-3) a first transfer portion R1 (turn T4→T5) in which the second wire 4 is changed in a direction from the end portion of the second wound portion W2 on the second end portion 8 side to the first end portion 7 side and is guided to the position of the third layer, (1-4) a third wound portion W3 (turns T5 to T6) in which the second wire 4 is connected to the first transfer portion R1 and is wound by N turns (here, two turns) in the third layer, (1-5) a second transfer portion R2 (turn T6→T7) in which the second wire 4 is guided from the third wound portion W3 to the position of the second layer, and (1-6) a fourth wound portion W4 (turns T7 to T8) in which the second wire 4 is connected to the second transfer portion R2 and is wound toward the second end portion 8 in the second layer.

Next, the second wound area Z2 is disposed after the first wound area Z1 described above. The layer in which each of the first wire 3 and the second wire 4 is located is replaced between the first wound area Z1 and the second wound area Z2. At the switching portion, the first wire 3 is guided from the end portion of the first wound portion W1 on the second end portion 8 side to the second layer, and the second wire 3 is guided from the end portion of the fourth wound portion W4 on the second end portion 8 side to the first layer.

The second wound area Z2 includes (2-1) a fifth wound portion W5 (turns T9 to T18) in which the second wire 4 is wound from the first end portion 7 toward the second end portion 8 in the first layer, (2-2) a sixth wound portion W6 (turns T9 to T13) in which the first wire 3 is wound to a middle of a range where the fifth wound portion W5 extends from the first end portion 7 toward the second end portion 8 in the second layer, (2-3) a third transfer portion R3 (turn T13→T14) in which the first wire 3 is changed in a direction from the end portion of the sixth wound portion W6 on the second end portion 8 side to the first end portion 7 side and is guided to the position of the third layer, (2-4) a seventh wound portion W7 (turn T14) in which the first wire 3 is connected to the third transfer portion R3 and is wound by M turns (here, one turn) in the third layer, (2-5) a fourth transfer portion R4 (turn T14→T15) in which the first wire 3 is guided from the seventh wound portion W7 to the position of the second layer, and (2-6) an eighth wound portion W8 (turns T15 to T18) in which the first wire 3 is connected to the fourth transfer portion R4 and is wound toward the second end portion 8 in the second layer.

Next, a third wound area Z3 is disposed after the second wound area Z2 described above. The layer in which each of the first wire 3 and the second wire 4 is located is replaced between the second wound area Z2 and the third wound area Z3. At the switching portion, the first wire 3 is guided from the end portion of the eighth wound portion W8 on the second end portion 8 side to the first layer, and the second wire 3 is guided from the end portion of the fifth wound portion W5 on the second end portion 8 side to the second layer.

The third wound area Z3 has substantially the same configuration as that of the first wound area Z1, and includes (3-1) a ninth wound portion W9 (turns T19 to T26) in which the first wire 3 is wound from the first end portion 7 toward the second end portion 8 in the first layer, (3-2) a tenth wound portion W10 (turns T19 to T22) in which the second wire 4 is wound to a middle of a range where the ninth wound portion W9 extends from the first end portion 7 toward the second end portion 8 in the second layer, (3-3) a fifth transfer portion R5 (turn T22→T23) in which the second wire 4 is changed in a direction from the end portion of the tenth wound portion W10 on the second end portion 8 side to the first end portion 7 side and is guided to the position of the third layer, (3-4) an eleventh wound portion W11 (turns T23 to T24) in which the second wire 4 is connected to the fifth transfer portion R5 and is wound by P turns (here, two turns) in the third layer, (3-5) a sixth transfer portion R6 (turn T24→T25) in which the second wire 4 is guided from the end portion of the eleventh wound portion W11 on the second end portion 8 side to the position of the second layer, and (3-6) a twelfth wound portion W12 (turns T25 to T26) in which the second wire 4 is connected to the sixth transfer portion R6 and is wound toward the second end portion 8 in the second layer.

According to the ninth embodiment, it is possible to make a positional shift of the wire located in the second layer be unlikely to occur.

In addition, in the first wound area Z1, a +0.5 turn shift area F1 in which a turn is shifted by 0.5 turns in the positive direction between the first wire 3 and the second wire 4 is present, on the first end portion 7 side of the boundary (turn T4/T7) between the second wound portion W2 and the fourth wound portion W4.

On the other hand, in the first wound area Z1, a −(N−0.5) turn shift area, specifically, a −1.5 turn shift area F2, in which a turn is shifted by (N−0.5) turns in the negative direction between the first wire 3 and the second wire 4 is present, on the second end portion 8 side of the boundary (turn T4/T7) between the second wound portion W2 and the fourth wound portion W4.

In addition, in the second wound area Z2, a −0.5 turn shift area F3 in which a turn is shifted by 0.5 turns in the negative direction between the first wire 3 and the second wire 4 is present, on the first end portion 7 side of the boundary (turn T13/T15) between the sixth wound portion W6 and the eighth wound portion W8.

On the other hand, in the second wound area Z2, a +(M−0.5) turn shift area, specifically, a +0.5 turn shift area F1, in which a turn is shifted by (M−0.5) turns in the positive direction between the first wire 3 and the second wire 4, is present on the second end portion 8 side of the boundary (turn T13/T15) between the sixth wound portion W6 and the eighth wound portion W8.

In addition, in the third wound area Z3, a +0.5 turn shift area F1 in which a turn is shifted by 0.5 turns in the positive direction between the first wire 3 and the second wire 4 is present, on the first end portion 7 side of the boundary (turn T22/T25) between the tenth wound portion W10 and the twelfth wound portion W12.

On the other hand, in the third wound area Z3, a −(P−0.5) turn shift area, specifically, a −1.5 turn shift area F2, in which a turn is shifted by (P−0.5) turns in the negative direction between the first wire 3 and the second wire 4 is present, on the second end portion 8 side of the boundary (turn T22/T25) between the ninth wound portion W9 and the twelfth wound portion W12.

With these configurations, the influence of the stray capacitance generated between the first wire 3 and the second wire 4 can be reduced, and for example, the mode conversion characteristics of the common mode choke coil can be reduced.

In addition, in the present embodiment, since the layer in which the first wire 3 and the second wire 4 is located is replaced in the first wound area Z1, the third wound area Z3, and the second wound area Z2, the difference between the length of the first wire 3 and the length of the second wire 4 can be reduced. This can also contribute to reducing the mode conversion characteristics in the common mode choke coil.

The arrangement of the wound areas along the winding core portion 5 may be further repeated.

### Tenth Embodiment

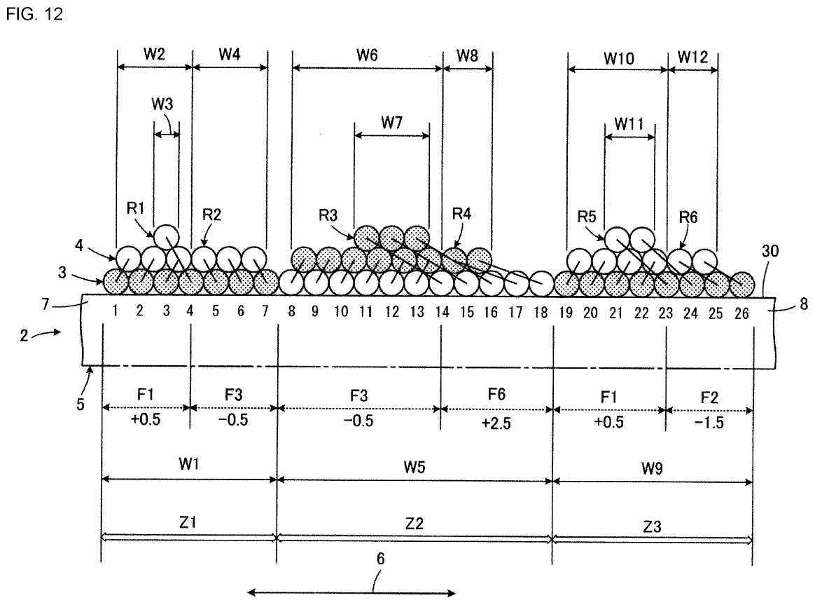

In the tenth embodiment shown in FIG. 12, three wound areas including a first wound area Z1, a second wound area Z2, and a third wound area Z3 are disposed in order along the axis direction 6 of the winding core portion 5, and the number of turns of the wire constituting the third layer differs among each of the first wound area Z1, the second wound area Z2, and the third wound area Z3.

The first wound area Z1 includes (1-1) a first wound portion W1 (turns T1 to T7) in which the first wire 3 is wound from the first end portion 7 toward the second end portion 8 in the first layer, (1-2) a second wound portion W2 (turns T1 to T3) in which the second wire 4 is wound to a middle of a range where the first wound portion W1 extends from the first end portion 7 toward the second end portion 8 in the second layer, (1-3) a first transfer portion R1 (turn T3→T4) in which the second wire 4 is changed in a direction from the end portion of the second wound portion W2 on the second end portion 8 side to the first end portion 7 side and is guided to the position of the third layer, (1-4) a third wound portion W3 (turn T4) in which the second wire 4 is connected to the first transfer portion R1 and is wound by N turns (here, one turn) in the third layer, (1-5) a second transfer portion R2 (turn T4→T5) in which the second wire 4 is guided from the third wound portion W3 to the position of the second layer, and (1-6) a fourth wound portion W4 (turns T5 to T7) in which the second wire 4 is connected to the second transfer portion R2 and is wound toward the second end portion 8 in the second layer.

Next, the second wound area Z2 is disposed after the first wound area Z1 described above. The layer in which each of the first wire 3 and the second wire 4 is located is replaced between the first wound area Z1 and the second wound area Z2. At the switching portion, the first wire 3 is guided from the end portion of the first wound portion W1 on the second end portion 8 side to the second layer, and the second wire 3 is guided from the end portion of the fourth wound portion W4 on the second end portion 8 side to the first layer.

The second wound area Z2 includes (2-1) a fifth wound portion W5 (turns T8 to T18) in which the second wire 4 is wound from the first end portion 7 toward the second end portion 8 in the first layer, (2-2) a sixth wound portion W6 (turns T8 to T13) in which the first wire 3 is wound to a middle of a range where the fifth wound portion W5 extends from the first end portion 7 toward the second end portion 8 in the second layer, (2-3) a third transfer portion R3 (turn T13→T14) in which the first wire 3 is changed in a direction from the end portion of the sixth wound portion W6 on the second end portion 8 side to the first end portion 7 side and is guided to the position of the third layer, (2-4) a seventh wound portion W7 (turns T14 to T16) in which the first wire 3 is connected to the third transfer portion R3 and is wound by M turns (three turns here) in the third layer, (2-5) a fourth transfer portion R4 (turn T16→T17) in which the first wire 3 is guided from the seventh wound portion W7 to the position of the second layer, and (2-6) an eighth wound portion W8 (turns T17 to T18) in which the first wire 3 is connected to the fourth transfer portion R4 and is wound toward the second end portion 8 in the second layer.

Next, a third wound area Z3 is disposed after the second wound area Z2 described above. The layer in which each of the first wire 3 and the second wire 4 is located is replaced between the second wound area Z2 and the third wound area Z3. At the switching portion, the first wire 3 is guided from the end portion of the eighth wound portion W8 on the second end portion 8 side to the first layer, and the second wire 3 is guided from the end portion of the fifth wound portion W5 on the second end portion 8 side to the second layer.

The third wound area Z3 includes (3-1) a ninth wound portion W9 (turns T19 to T26) in which the first wire 3 is wound from the first end portion 7 toward the second end portion 8 in the first layer, (3-2) a tenth wound portion W10 (turns T19 to T22) in which the second wire 4 is wound to a middle of a range where the ninth wound portion W9 extends from the first end portion 7 toward the second end portion 8 in the second layer, (3-3) a fifth transfer portion R5 (turn T22→T23) in which the second wire 4 is changed in a direction from the end portion of the tenth wound portion W10 on the second end portion 8 side to the first end portion 7 side and is guided to the position of the third layer, (3-4) an eleventh wound portion W11 (turns T23 to T24) in which the second wire 4 is connected to the fifth transfer portion R5 and is wound by P turns (here, two turns) in the third layer, (3-5) a sixth transfer portion R6 (turn T24→T25) in which the second wire 4 is guided from the end portion of the eleventh wound portion W11 on the second end portion 8 side to the position of the second layer, and (3-6) a twelfth wound portion W12 (turns T25 to T26) in which the second wire 4 is connected to the sixth transfer portion R6 and is wound toward the second end portion 8 in the second layer.

According to the tenth embodiment, it is possible to make a positional shift of the wire located in the second layer be unlikely to occur.

In addition, in the first wound area Z1, a +0.5 turn shift area F1 in which a turn is shifted by 0.5 turns in the positive direction between the first wire 3 and the second wire 4 is present, on the first end portion 7 side of the boundary (turn T3/T5) between the second wound portion W2 and the fourth wound portion W4.

On the other hand, in the first wound area Z1, a −(N−0.5) turn shift area, specifically, a −0.5 turn shift area F3, in which a turn is shifted by (N−0.5) turns in the negative direction between the first wire 3 and the second wire 4, is present on the second end portion 8 side of the boundary (turn T3/T5) between the second wound portion W2 and the fourth wound portion W4.

In addition, in the second wound area Z2, a −0.5 turn shift area F3 in which a turn is shifted by 0.5 turns in the negative direction between the first wire 3 and the second wire 4 is present, on the first end portion 7 side of the boundary (turn T13/T16) between the sixth wound portion W6 and the eighth wound portion W8.

On the other hand, in the second wound area Z2, a +(M−0.5) turn shift area, specifically, a +2.5 turn shift area F6, in which a turn is shifted by (M−0.5) turns in the positive direction between the first wire 3 and the second wire 4, is present on the second end portion 8 side of the boundary (turn T13/T16) between the sixth wound portion W6 and the eighth wound portion W8.

In addition, in the third wound area Z3, a +0.5 turn shift area F1 in which a turn is shifted by 0.5 turns in the positive direction between the first wire 3 and the second wire 4 is present, on the first end portion 7 side of the boundary (turn T22/T25) between the tenth wound portion W10 and the twelfth wound portion W12.

On the other hand, in the third wound area Z3, a −(P−0.5) turn shift area, specifically, a −1.5 turn shift area F2, in which a turn is shifted by (P−0.5) turns in the negative direction between the first wire 3 and the second wire 4 is present, on the second end portion 8 side of the boundary (turn T22/T25) between the ninth wound portion W9 and the twelfth wound portion W12.

With these configurations, the influence of the stray capacitance generated between the first wire 3 and the second wire 4 can be reduced, and for example, the mode conversion characteristics of the common mode choke coil can be reduced.

In addition, in the present embodiment, since the layer in which the first wire 3 and the second wire 4 is located is replaced in the first wound area Z1, the third wound area Z3, and the second wound area Z2, the difference between the length of the first wire 3 and the length of the second wire 4 can be reduced. This can also contribute to reducing the mode conversion characteristics in the common mode choke coil.

The arrangement of the wound areas along the winding core portion 5 may be further repeated.

### Eleventh Embodiment

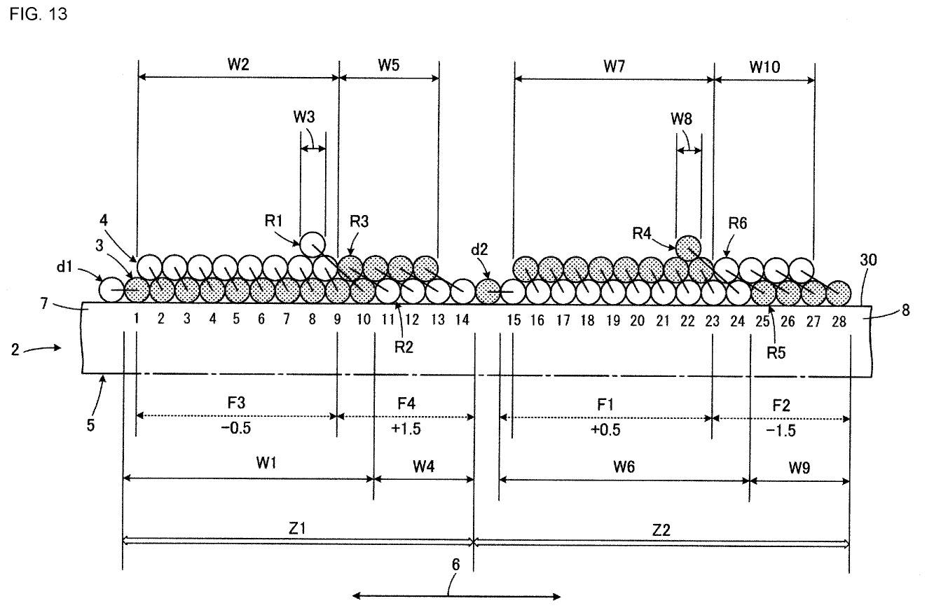

The eleventh embodiment shown in FIG. 13 has two wound areas, the first wound area Z1 and the second wound area Z2, disposed in order along the axis direction 6 of the winding core portion 5, and for example differs in that a dislocation destination of the wire constituting the third layer is the first layer instead of the second layer, as compared with the configuration of the fourth embodiment.

The first wound area Z1 includes (1-1) a first wound portion W1 (turns T1 to T10) in which the first wire 3 is wound from the first end portion 7 toward the second end portion 8 in the first layer, (1-1a) an intentionally stepped portion d1 (turn T1) in which the second wire 4 to be located in the second layer is intentionally wound in a first layer adjacent to the end portion of the first wound portion W1 on the first end portion 7 side, (1-2) a second wound portion W2 (turns T2 to T9) in which the second wire 4 is wound to a middle of a range where the first wound portion W1 extends from the first end portion 7 toward the second end portion 8 in the second layer, (1-3) a first transfer portion R1 (turn T9→T10) in which the second wire 4 is changed in a direction from the end portion of the second wound portion W2 on the second end portion 8 side to the first end portion 7 side and is guided to the position of the third layer, (1-4) a third wound portion W3 (turn T10) in which the second wire 4 is connected to the first transfer portion R1 and is wound by N turns (here, one turn) in the third layer, (1-5) a second transfer portion R2 (turn T10→T11) in which the second wire 4 is guided from the end portion of the third wound portion W3 on the second end portion 8 side to the position of the first layer on the second end portion 8 side than the end portion of the first wound portion W1 on the second end portion 8 side, (1-6) a fourth wound portion W4 (turns T11 to T14) in which the second wire 4 is connected to the second transfer portion R2 and is wound toward the second end portion 8 in the first layer, (1-7) a third transfer portion R3 (turn T10→T11) in which the first wire 3 is changed in a direction from the end portion of the first wound portion W1 on the second end portion 8 side to the first end portion 7 side and is guided to the position of the second layer on the first wound portion W1, and (1-8) a fifth wound portion W5 (turn T11 to T14) in which the first wire 3 is connected to the third transfer portion R3 and is wound toward the second end portion 8 on the fourth wound portion W4 in the second layer.

Next, the second wound area Z2 is disposed after the first wound area Z1 described above. The layer in which each of the first wire 3 and the second wire 4 is located is replaced between the first wound area Z1 and the second wound area Z2.

The second wound area Z2 includes (2-1) a sixth wound portion W6 (turns T15 to T24) in which the second wire 4 is wound from the first end portion 7 toward the second end portion 8 in the first layer, (2-1a) an intentionally stepped portion d2 (turn T15) in which the first wire 3 to be located in the second layer is intentionally wound in a first layer adjacent to the end portion of the sixth wound portion W6 on the first end portion 7 side, (2-2) a seventh wound portion W7 (turns T16 to T23) in which the first wire 3 is wound to a middle of a range where the sixth wound portion W6 extends from the first end portion 7 toward the second end portion 8 in the second layer, (2-3) a fourth transfer portion R4 (turn T23→T24) in which the first wire 3 is changed in a direction from the end portion of the seventh wound portion W7 on the second end portion 8 side to the first end portion 7 side and is guided to the position of the third layer, (2-4) an eighth wound portion W8 (turn T24) in which the first wire 3 is connected to the fourth transfer portion R4 and is wound by M turns (here, one turn) in the third layer, (2-5) a fifth transfer portion R5 (turn T24→T25) in which the first wire 3 is guided from the end portion of the eighth wound portion W8 on the second end portion 8 side to the position of the first layer on the second end portion 8 side than the end portion of the sixth wound portion W6 on the second end portion 8 side, (2-6) a ninth wound portion W9 (turns T25 to T28) in which the first wire 3 is connected to the fifth transfer portion R5 and is wound toward the second end portion 8 in the first layer, (2-7) a sixth transfer portion R6 (turn T24→T25) in which the second wire 4 is changed in a direction from the end portion of the sixth wound portion W6 on the second end portion 8 side to the first end portion 7 side and is guided to the position of the second layer on the sixth wound portion W6, and (2-8) a tenth wound portion W10 (turn T25 to T28) in which the second wire 4 is connected to the sixth transfer portion R6 and is wound toward the second end portion 8 on the ninth wound portion W9 in the second layer.

According to the eleventh embodiment, it is possible to make a positional shift of the wire located in the second layer be unlikely to occur.

In addition, in the first wound area Z1, a −0.5 turn shift area F3 in which a turn is shifted by 0.5 turns in the negative direction between the first wire 3 and the second wire 4 is present, on the first end portion 7 side of the boundary (turn T9/T11) between the second wound portion W2 and the fifth wound portion W5.

On the other hand, in the first wound area Z1, a +(N+0.5) turn shift area, specifically, a +1.5 turn shift area F4, in which a turn is shifted by (N+0.5) turns in the positive direction between the first wire 3 and the second wire 4 is present, on the second end portion 8 side of the boundary (turn T9/T11) between the second wound portion W2 and the fifth wound portion W5.

In addition, in the second wound area Z2, a +0.5 turn shift area F1 in which a turn is shifted by 0.5 turns in the positive direction between the first wire 3 and the second wire 4 is present, on the first end portion 7 side of the boundary (turn T23/T25) between the seventh wound portion W7 and the tenth wound portion W10.

On the other hand, a −(M+0.5) turn shift area, specifically, a −1.5 turn shift area F2, in which a turn is shifted by (M+0.5) turns in the negative direction between the first wire 3 and the second wire 4 is present, on the second end portion 8 side of the boundary (turn T23/T25) between the seventh wound portion W7 and the tenth wound portion W10.

With these configurations, the influence of the stray capacitance generated between the first wire 3 and the second wire 4 can be reduced, and for example, the mode conversion characteristics of the common mode choke coil can be reduced.

In addition, in the present embodiment, since the layer in which each of the first wire 3 and the second wire 4 is located is replaced in the first wound area Z1 and the second wound area Z2, the difference between the length of the first wire 3 and the length of the second wire 4 can be reduced. This can also contribute to reducing the mode conversion characteristics in the common mode choke coil.

### Twelfth Embodiment

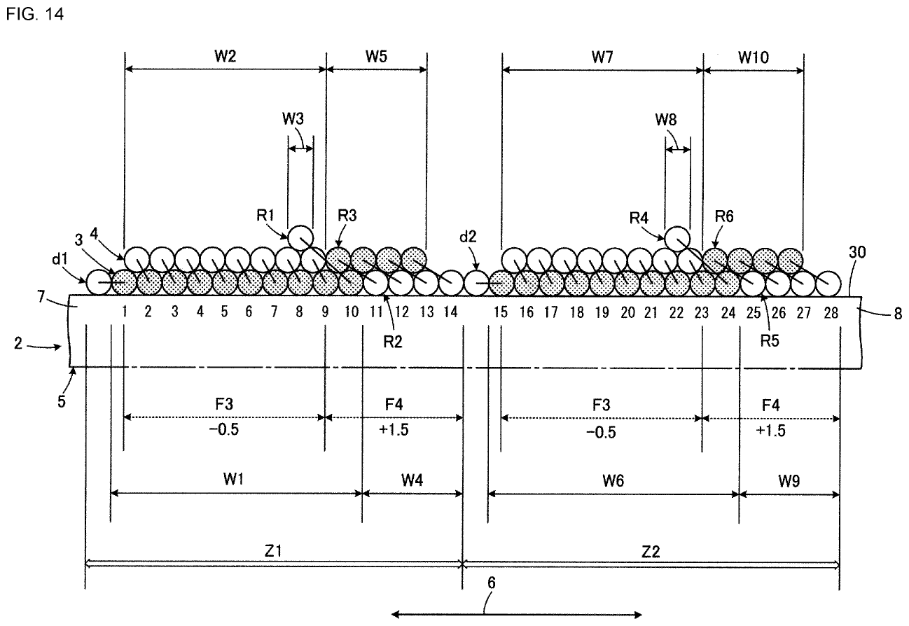

In the twelfth embodiment shown in FIG. 14, two wound areas including a first wound area Z1 and a second wound area Z2 are disposed in order along the axis direction 6 of the winding core portion 5, and a dislocation destination of the wire constituting the third layer is the first layer, similarly to the configuration of the eleventh embodiment.

Similarly to the configuration of the first wound area Z1 according to the eleventh embodiment, the first wound area Z1 includes (1-1) a first wound portion W1 (turns T1 to T10) in which the first wire 3 is wound from the first end portion 7 toward the second end portion 8 in the first layer, (1-1a) an intentionally stepped portion d1 (turn T1) in which the second wire 4 to be located in the second layer is intentionally wound in a first layer adjacent to the end portion of the first wound portion W1 on the first end portion 7 side, (1-2) a second wound portion W2 (turns T2 to T9) in which the second wire 4 is wound to a middle of a range where the first wound portion W1 extends from the first end portion 7 toward the second end portion 8 in the second layer, (1-3) a first transfer portion R1 (turn T9→T10) in which the second wire 4 is changed in a direction from the end portion of the second wound portion W2 on the second end portion 8 side to the first end portion 7 side and is guided to the position of the third layer, (1-4) a third wound portion W3 (turn T10) in which the second wire 4 is connected to the first transfer portion R1 and is wound by N turns (here, one turn) in the third layer, (1-5) a second transfer portion R2 (turn T10→T11) in which the second wire 4 is guided from the end portion of the third wound portion W3 on the second end portion 8 side to the position of the first layer on the second end portion 8 side than the end portion of the first wound portion W1 on the second end portion 8 side, (1-6) a fourth wound portion W4 (turns Ti1 to T14) in which the second wire 4 is connected to the second transfer portion R2 and is wound toward the second end portion 8 in the first layer, (1-7) a third transfer portion R3 (turn T10→T11) in which the first wire 3 is changed in a direction from the end portion of the first wound portion W1 on the second end portion 8 side to the first end portion 7 side and is guided to the position of the second layer on the first wound portion W1, and (1-8) a fifth wound portion W5 (turn T11 to T14) in which the first wire 3 is connected to the third transfer portion R3 and is wound toward the second end portion 8 on the fourth wound portion W4 in the second layer.

In the first wound area Z1 described above, the layer in which the first wire 3 is located is replaced between the first wound portion W1 and the fifth wound portion W5, and the layer in which the second wire 4 is located is replaced between the second wound portion W2 and the fourth wound portion W4.

Similarly to the configuration of the first wound area Z1 described above, the second wound area Z2 includes (2-1) a sixth wound portion W6 (turns T15 to T24) in which the first wire 3 is wound from the first end portion 7 toward the second end portion 8 in the first layer, (2-1a) an intentionally stepped portion d2 (turn T15) in which the second wire 4 to be located in the second layer is intentionally wound in a first layer adjacent to the end portion of the sixth wound portion W6 on the first end portion 7 side, (2-2) a seventh wound portion W7 (turns T16 to T23) in which the second wire 4 is wound to a middle of a range where the sixth wound portion W6 extends from the first end portion 7 toward the second end portion 8 in the second layer, (2-3) a fourth transfer portion R4 (turn T23→T24) in which the second wire 4 is changed in a direction from the end portion of the seventh wound portion W7 on the second end portion 8 side to the first end portion 7 side and is guided to the position of the third layer, (2-4) an eighth wound portion W8 (turn T24) in which the second wire 4 is connected to the fourth transfer portion R4 and is wound by M turns (here, one turn) in the third layer, (2-5) a fifth transfer portion R5 (turn T24→T25) in which the second wire 4 is guided from the end portion of the eighth wound portion W8 on the second end portion 8 side to the position of the first layer on the second end portion 8 side than the end portion of the sixth wound portion W6 on the second end portion 8 side, (2-6) a ninth wound portion W9 (turns T25 to T28) in which the second wire 4 is connected to the fifth transfer portion R5 and is wound toward the second end portion 8 in the first layer, (2-7) a sixth transfer portion R6 (turn T24→T25) in which the first wire 3 is changed in a direction from the end portion of the sixth wound portion W6 on the second end portion 8 side to the first end portion 7 side and is guided to the position of the second layer on the sixth wound portion W6, and (2-8) a tenth wound portion W10 (turn T25 to T28) in which the first wire 3 is connected to the sixth transfer portion R6 and is wound toward the second end portion 8 on the ninth wound portion W9 in the second layer.

In the second wound area Z2 described above, the layer in which the first wire 3 is located is replaced between the sixth wound portion W6 and the tenth wound portion W10, and the layer in which the second wire 4 is located is replaced between the seventh wound portion W7 and the ninth wound portion W9.

According to the twelfth embodiment, it is possible to make a positional shift of the wire located in the second layer be unlikely to occur.

In addition, in the first wound area Z1, a −0.5 turn shift area F3 in which a turn is shifted by 0.5 turns in the negative direction between the first wire 3 and the second wire 4 is present, on the first end portion 7 side of the boundary (turn T9/T11) between the second wound portion W2 and the fifth wound portion W5.

On the other hand, in the first wound area Z1, a +(N+0.5) turn shift area, specifically, a +1.5 turn shift area F4, in which a turn is shifted by (N+0.5) turns in the positive direction between the first wire 3 and the second wire 4 is present, on the second end portion 8 side of the boundary (turn T9/T11) between the second wound portion W2 and the fifth wound portion W5.

In addition, in the second wound area Z2, a −0.5 turn shift area F3 in which a turn is shifted by 0.5 turns in the negative direction between the first wire 3 and the second wire 4 is present, on the first end portion 7 side of the boundary (turn T23/T25) between the seventh wound portion W7 and the tenth wound portion W10.

On the other hand, a +(M+0.5) turn shift area, specifically, a +1.5 turn shift area F4, in which a turn is shifted by (M+0.5) turns in the positive direction between the first wire 3 and the second wire 4 is present, on the second end portion 8 side of the boundary (turn T23/T25) between the seventh wound portion W7 and the tenth wound portion W10.

With these configurations, the influence of the stray capacitance generated between the first wire 3 and the second wire 4 can be reduced, and for example, the mode conversion characteristics of the common mode choke coil can be reduced.

In addition, in the present embodiment, since the layer in which each of the first wire 3 and the second wire 4 is located is replaced in each of the first wound area Z1 and the second wound area Z2, the difference between the length of the first wire 3 and the length of the second wire 4 can be reduced. This can also contribute to reducing the mode conversion characteristics in the common mode choke coil.

In each of the embodiments described above, the number of turns of the wires 3 and 4 is merely an example, and can be increased or decreased as necessary.

Although the present disclosure has been described above in conjunction with the embodiment according to the coil component constituting the common mode choke coil, the present disclosure can be applied to other components, for example, a wire-wound chip transformer. In addition, each shown embodiment is an example, and partial replacement or combination of configurations is possible between different embodiments.

The present disclosure has the following embodiments.

<1> A coil component including a core that includes a winding core portion having a first end portion and a second end portion opposite to each other in an axis direction, and a first wire and a second wire spirally wound around the winding core portion and having substantially the same number of turns as each other. Among a plurality of layers formed by the first wire and the second wire wound around the winding core portion, a layer closest to a peripheral surface of the winding core portion is referred to as a first layer, a layer wound on an outer peripheral side of the first layer while being fitted in a recessed portion formed between adjacent turns of a wire located in the first layer is referred to as a second layer, and a layer wound on an outer peripheral side of the second layer while being fitted in a recessed portion formed between adjacent turns of a wire located in the second layer is referred to as a third layer. A plurality of wound areas including at least a first wound area and a second wound area in which winding states of the first wire and the second wire are different from each other are disposed along the axis direction. The first wound area includes (1-1) a first wound portion in which the first wire is wound from the first end portion toward the second end portion in the first layer, (1-2) a second wound portion in which the second wire is wound to a middle of a range where the first wound portion extends from the first end portion toward the second end portion in the second layer, (1-3) a first transfer portion in which the second wire is changed in a direction from an end portion of the second wound portion on a second end portion side to a first end portion side and is guided to a position of the third layer, (1-4) a third wound portion in which the second wire is connected to the first transfer portion and is wound by N turns (N is a natural number) in the third layer, (1-5) a second transfer portion in which the second wire is guided from the third wound portion to a position of the second layer, and (1-6) a fourth wound portion in which the second wire is connected to the second transfer portion and is wound toward the second end portion in the second layer. A layer in which each of the first wire and the second wire is located is replaced between the first wound area and the second wound area. The second wound area includes (2-1) a fifth wound portion in which the second wire is wound from the first end portion toward the second end portion in the first layer, (2-2) a sixth wound portion in which the first wire is wound to a middle of a range where the fifth wound portion extends from the first end portion toward the second end portion in the second layer, (2-3) a third transfer portion in which the first wire is changed in a direction from an end portion of the sixth wound portion on the second end portion side to the first end portion side and is guided to a position of the third layer, (2-4) a seventh wound portion in which the first wire is connected to the third transfer portion and is wound by M turns (M is a natural number) in the third layer, (2-5) a fourth transfer portion in which the first wire is guided from the seventh wound portion to a position of the second layer, and (2-6) an eighth wound portion in which the first wire is connected to the fourth transfer portion and is wound toward the second end portion in the second layer. Regarding a direction of a shift between the first wire and the second wire, when the shift is defined as a shift in a positive direction in a case where a turn of the second wire is on the second end portion side from a turn of the first wire with the same number as the turn of the second wire, and the shift is defined as a shift in a negative direction in an opposite case, a positive direction shift area in which a turn is shifted in the positive direction and a negative direction shift area in which a turn is shifted in the negative direction between the first wire and the second wire are present in each of the first wound area and the second wound area.

<2> The coil component according to <1> in which the positive direction shift area is present on one of the first end portion side and the second end portion side of a boundary between the second wound portion and the fourth wound portion, the negative direction shift area is present on the other of the first end portion side and the second end portion side of the boundary between the second wound portion and the fourth wound portion, the negative direction shift area is present on one of the first end portion side and the second end portion side of a boundary between the sixth wound portion and the eighth wound portion, and the positive direction shift area is present on the other of the first end portion side and the second end portion side of the boundary between the sixth wound portion and the eighth wound portion.

<3> The coil component according to <2> in which a +0.5 turn shift area in which a turn is shifted by 0.5 turns in the positive direction between the first wire and the second wire is present, on one of the first end portion side and the second end portion side of the boundary between the second wound portion and the fourth wound portion. A−(N−0.5) turn shift area in which a turn is shifted by (N−0.5) turns in the negative direction between the first wire and the second wire is present, on the other of the first end portion side and the second end portion side of the boundary between the second wound portion and the fourth wound portion. A −0.5 turn shift area in which a turn is shifted by 0.5 turns in the negative direction between the first wire and the second wire is present, on one of the first end portion side and the second end portion side of the boundary between the sixth wound portion and the eighth wound portion. A +(M−0.5) turn shift area in which a turn is shifted by (M−0.5) turns in the positive direction between the first wire and the second wire is present, on the other of the first end portion side and the second end portion side of the boundary between the sixth wound portion and the eighth wound portion.

<4> The coil component according to any one of <1> to <3>, in which the number of turns that the second wire is wound around the winding core portion in the third wound portion and the number of turns that the first wire is wound around the winding core portion in the eighth wound portion are different from each other.

<5> A coil component including a core that includes a winding core portion having a first end portion and a second end portion opposite to each other in an axis direction, and a first wire and a second wire spirally wound around the winding core portion and having substantially the same number of turns as each other. Among a plurality of layers formed by the first wire and the second wire wound around the winding core portion, a layer closest to a peripheral surface of the winding core portion is referred to as a first layer, a layer wound on an outer peripheral side of the first layer while being fitted in a recessed portion formed between adjacent turns of a wire located in the first layer is referred to as a second layer, and a layer wound on an outer peripheral side of the second layer while being fitted in a recessed portion formed between adjacent turns of a wire located in the second layer is referred to as a third layer. A plurality of wound areas including at least a first wound area and a second wound area in which winding states of the first wire and the second wire are different from each other are disposed along the axis direction. The first wound area includes (1-1) a first wound portion in which the first wire is wound from the first end portion toward the second end portion in the first layer, (1-2) a second wound portion in which the second wire is wound to a middle of a range where the first wound portion extends from the first end portion toward the second end portion in the second layer, (1-3) a first transfer portion in which the second wire is changed in a direction from an end portion of the second wound portion on a second end portion side to a first end portion side and is guided to a position of the third layer, (1-4) a third wound portion in which the second wire is connected to the first transfer portion and is wound by N turns (N is a natural number) in the third layer, (1-5) a second transfer portion in which the second wire is guided from the third wound portion to a position of the first layer, (1-6) a fourth wound portion in which the second wire is connected to the second transfer portion and is wound toward the second end portion in the first layer, (1-7) a third transfer portion in which the first wire is changed in a direction from an end portion of the first wound portion on the second end portion side to the first end portion side and is guided to a position of the second layer, and (1-8) a fifth wound portion in which the first wire is connected to the third transfer portion and is wound toward the second end portion in the second layer. A layer in which each of the first wire and the second wire is located is replaced between the first wound area and the second wound area. The second wound area includes (2-1) a sixth wound portion in which the second wire is wound from the first end portion toward the second end portion in the first layer, (2-2) a seventh wound portion in which the first wire is wound to a middle of a range where the sixth wound portion extends from the first end portion toward the second end portion in the second layer, (2-3) a fourth transfer portion in which the first wire is changed in a direction from an end portion of the seventh wound portion on the second end portion side to the first end portion side and is guided to a position of the third layer, (2-4) an eighth wound portion in which the first wire is connected to the fourth transfer portion and is wound by M turns (M is a natural number) in the third layer, (2-5) a fifth transfer portion in which the first wire is guided from the eighth wound portion to a position of the first layer, (2-6) a ninth wound portion in which the first wire is connected to the fifth transfer portion and is wound toward the second end portion in the first layer, (2-7) a sixth transfer portion in which the second wire is changed in a direction from an end portion of the sixth wound portion on the second end portion side to the first end portion side and is guided to a position of the second layer, and (2-8) a tenth wound portion in which the second wire is connected to the sixth transfer portion and is wound toward the second end portion in the second layer. Regarding a direction of a shift between the first wire and the second wire, when the shift is defined as a shift in a positive direction in a case where a turn of the second wire is on the second end portion side from a turn of the first wire with the same number as the turn of the second wire, and the shift is defined as a shift in a negative direction in an opposite case, a positive direction shift area in which a turn is shifted in the positive direction and a negative direction shift area in which a turn is shifted in the negative direction between the first wire and the second wire are present in each of the first wound area and the second wound area.

<6> A coil component including a core that includes a winding core portion having a first end portion and a second end portion opposite to each other in an axis direction, and a first wire and a second wire spirally wound around the winding core portion and having substantially the same number of turns as each other. Among a plurality of layers formed by the first wire and the second wire wound around the winding core portion, a layer closest to a peripheral surface of the winding core portion is referred to as a first layer, a layer wound on an outer peripheral side of the first layer while being fitted in a recessed portion formed between adjacent turns of a wire located in the first layer is referred to as a second layer, and a layer wound on an outer peripheral side of the second layer while being fitted in a recessed portion formed between adjacent turns of a wire located in the second layer is referred to as a third layer. A plurality of wound areas including at least a first wound area and a second wound area are disposed along the axis direction. The first wound area includes (1-1) a first wound portion in which the first wire is wound from the first end portion toward the second end portion in the first layer, (1-2) a second wound portion in which the second wire is wound to a middle of a range where the first wound portion extends from the first end portion toward the second end portion in the second layer, (1-3) a first transfer portion in which the second wire is changed in a direction from an end portion of the second wound portion on a second end portion side to a first end portion side and is guided to a position of the third layer, (1-4) a third wound portion in which the second wire is connected to the first transfer portion and is wound by N turns (N is a natural number) in the third layer, (1-5) a second transfer portion in which the second wire is guided from the third wound portion to a position of the first layer, (1-6) a fourth wound portion in which the second wire is connected to the second transfer portion and is wound toward the second end portion in the first layer, (1-7) a third transfer portion in which the first wire is changed in a direction from an end portion of the first wound portion on the second end portion side to the first end portion side and is guided to a position of the second layer, and (1-8) a fifth wound portion in which the first wire is connected to the third transfer portion and is wound toward the second end portion in the second layer. A layer in which the first wire is located is replaced between the first wound portion and the fifth wound portion, and a layer in which the second wire is located is replaced between the second wound portion and the fourth wound portion. The second wound area includes (2-1) a sixth wound portion in which the first wire is wound from the first end portion toward the second end portion in the first layer, (2-2) a seventh wound portion in which the second wire is wound to a middle of a range where the sixth wound portion extends from the first end portion toward the second end portion in the second layer, (2-3) a fourth transfer portion in which the second wire is changed in a direction from an end portion of the seventh wound portion on the second end portion side to the first end portion side and is guided to a position of the third layer, (2-4) an eighth wound portion in which the second wire is connected to the fourth transfer portion and is wound by M turns (M is a natural number) in the third layer, (2-5) a fifth transfer portion in which the second wire is guided from the eighth wound portion to a position of the first layer, (2-6) a ninth wound portion in which the second wire is connected to the fifth transfer portion and is wound toward the second end portion in the first layer, (2-7) a sixth transfer portion in which the first wire is changed in a direction from an end portion of the sixth wound portion on the second end portion side to the first end portion side and is guided to a position of the second layer, and (2-8) a tenth wound portion in which the first wire is connected to the sixth transfer portion and is wound toward the second end portion in the second layer. A layer in which the first wire is located is replaced between the sixth wound portion and the tenth wound portion, and a layer in which the second wire is located is replaced between the seventh wound portion and the ninth wound portion. Regarding a direction of a shift between the first wire and the second wire, when the shift is defined as a shift in a positive direction in a case where a turn of the second wire is on the second end portion side from a turn of the first wire with the same number as the turn of the second wire, and the shift is defined as a shift in a negative direction in an opposite case, a positive direction shift area in which a turn is shifted in the positive direction and a negative direction shift area in which a turn is shifted in the negative direction between the first wire and the second wire are present in each of the first wound area and the second wound area.

<7> The coil component according to <5> or <6> in which the negative direction shift area is present on one of the first end portion side and the second end portion side of a boundary between the second wound portion and the fifth wound portion. The positive direction shift area is present on the other of the first end portion side and the second end portion side of the boundary between the second wound portion and the fifth wound portion. The positive direction shift area is present on one of the first end portion side and the second end portion side of a boundary between the seventh wound portion and the tenth wound portion, and the negative-positive direction shift area is present on the other of the first end portion side and the second end portion side of the boundary between the seventh wound portion and the tenth wound portion.

<8> The coil component according to <7> in which a −0.5 turn shift area in which a turn is shifted by 0.5 turns in the negative direction between the first wire and the second wire is present, on one of the first end portion side and the second end portion side of the boundary between the second wound portion and the fifth wound portion. A+(N−0.5) turn shift area in which a turn is shifted by (N−0.5) turns in the positive direction between the first wire and the second wire is present, on the other of the first end portion side and the second end portion side of the boundary between the second wound portion and the fifth wound portion. A+0.5 turn shift area in which a turn is shifted by 0.5 turns in the positive direction between the first wire and the second wire is present, on one of the first end portion side and the second end portion side of the boundary between the seventh wound portion and the tenth wound portion. A−(N−0.5) turn shift area in which a turn is shifted by (N−0.5) turns in the negative direction between the first wire and the second wire is present, on the other of the first end portion side and the second end portion side of the boundary between the seventh wound portion and the tenth wound portion.

<9> The coil component according to <7> in which a −0.5 turn shift area in which a turn is shifted by 0.5 turns in the negative direction between the first wire and the second wire is present, on one of the first end portion side and the second end portion side of the boundary between the second wound portion and the fifth wound portion. A+(N+0.5) turn shift area in which a turn is shifted by (N+0.5) turns in the positive direction between the first wire and the second wire is present, on the other of the first end portion side and the second end portion side of the boundary between the second wound portion and the fifth wound portion. A+0.5 turn shift area in which a turn is shifted by 0.5 turns in the positive direction between the first wire and the second wire is present, on one of the first end portion side and the second end portion side of the boundary between the seventh wound portion and the tenth wound portion. A−(M+0.5) turn shift area is present in which a turn is shifted by (M+0.5) turns in the negative direction between the first wire and the second wire is present, on the other of the first end portion side and the second end portion side of the boundary between the seventh wound portion and the tenth wound portion.

<10> The coil component according to any one of <5> to <9>, in which the number of turns that the second wire is wound around the winding core portion in the third wound portion and the number of turns that the first wire is wound around the winding core portion in the eighth wound portion are different from each other.

<11> The coil component according to any one of <1> to <10>, in which the second wire has an intentionally stepped portion in contact with the peripheral surface of the winding core portion side by side with the first layer where the first wire is located in an end portion of the first wound portion on the first end portion side.

What is claimed is:

1. A coil component comprising:
a core that includes a winding core portion having a first end portion and a second end portion opposite to each other in an axis direction; and
a first wire and a second wire spirally wound around the winding core portion and having substantially the same number of turns as each other, wherein
among a plurality of layers configured by the first wire and the second wire wound around the winding core portion, when a first layer is a layer closest to a peripheral surface of the winding core portion, a second layer is a layer wound on an outer peripheral side of the first layer while being fitted in a recessed portion between adjacent turns of a wire located in the first layer, and a third layer is a layer wound on an outer peripheral side of the second layer while being fitted in a recessed portion between adjacent turns of a wire located in the second layer,
a plurality of wound areas including at least a first wound area and a second wound area in which winding states of the first wire and the second wire are different from each other are along the axis direction,
the first wound area includes
a first wound portion in which the first wire is wound in a direction from the first end portion toward the second end portion in the first layer,
a second wound portion in which the second wire is wound in a direction from the first end portion toward the second end portion in the second layer to a partway of a range of the first wound portion,
a first transfer portion in which winding direction of the second wire is changed from an end of the second wound portion on the second end portion side toward the first end portion side, and the second wire is guided to a position of the third layer,
a third wound portion in which the second wire is connected to the first transfer portion and is wound by N turns (N is a natural number) in the third layer,
a second transfer portion in which the second wire is guided from the third wound portion to a position of the second layer, and
a fourth wound portion in which the second wire is connected to the second transfer portion and is wound toward the second end portion in the second layer,
a position of each of the first wire and the second wire is switched between the first wound area and the second wound area,
the second wound area includes
a fifth wound portion in which the second wire is wound in a direction from the first end portion toward the second end portion in the first layer,
a sixth wound portion in which the first wire is wound in a direction from the first end portion toward the second end portion in the second layer to a partway of a range of the fifth wound portion,
a third transfer portion in which winding direction of the first wire is changed from an end of the sixth wound portion on the second end portion side toward the first end portion side, and the first wire is guided to a position of the third layer,
a seventh wound portion in which the first wire is connected to the third transfer portion and is wound by M turns (M is a natural number) in the third layer,
a fourth transfer portion in which the first wire is guided from the seventh wound portion to a position of the second layer, and
an eighth wound portion in which the first wire is connected to the fourth transfer portion and is wound toward the second end portion in the second layer, and
regarding a direction of a shift between the first wire and the second wire, when a shift in a positive direction is defined in a case where a turn of the second wire is closer to the second end portion side than a turn of the first wire with the same turn number as the turn of the second wire, and a shift in a negative direction is defined as in an opposite case,
a positive direction shift area in which a turn is shifted in the positive direction between the first wire and the second wire, and a negative direction shift area in which a turn is shifted in the negative direction between the first wire and the second wire, are in each of the first wound area and the second wound area.

2. The coil component according to claim 1, wherein
the positive direction shift area is on one of the first end portion side and the second end portion side of a boundary between the second wound portion and the fourth wound portion,
the negative direction shift area is on the other of the first end portion side and the second end portion side of the boundary between the second wound portion and the fourth wound portion,
the negative direction shift area is on one of the first end portion side and the second end portion side of a boundary between the sixth wound portion and the eighth wound portion, and
the positive direction shift area is on the other of the first end portion side and the second end portion side of the boundary between the sixth wound portion and the eighth wound portion.

3. The coil component according to claim 2, wherein
a +0.5 turn shift area in which a turn is shifted by 0.5 turns in the positive direction between the first wire and the second wire is present, on one of the first end portion side and the second end portion side of the boundary between the second wound portion and the fourth wound portion,
a −(N−0.5) turn shift area in which a turn is shifted by (N−0.5) turns in the negative direction between the first wire and the second wire is present, on the other of the first end portion side and the second end portion side of the boundary between the second wound portion and the fourth wound portion,
a −0.5 turn shift area in which a turn is shifted by 0.5 turns in the negative direction between the first wire and the second wire is present, on one of the first end portion side and the second end portion side of the boundary between the sixth wound portion and the eighth wound portion, and
a +(M−0.5) turn shift area in which a turn is shifted by (M−0.5) turns in the positive direction between the first wire and the second wire is present, on the other of the first end portion side and the second end portion side of the boundary between the sixth wound portion and the eighth wound portion.

4. The coil component according to claim 1, wherein
the number of turns that the second wire is wound around the winding core portion in the third wound portion is different from the number of turns that the first wire is wound around the winding core portion in the eighth wound portion with each other.

5. A coil component comprising:
a core that includes a winding core portion having a first end portion and a second end portion opposite to each other in an axis direction; and
a first wire and a second wire spirally wound around the winding core portion and having substantially the same number of turns as each other, wherein
among a plurality of layers configured by the first wire and the second wire wound around the winding core portion, when a first layer is a layer closest to a peripheral surface of the winding core portion, a second layer is a layer wound on an outer peripheral side of the first layer while being fitted in a recessed portion between adjacent turns of a wire located in the first layer, and a third layer is a layer wound on an outer peripheral side of the second layer while being fitted in a recessed portion between adjacent turns of a wire located in the second layer,
a plurality of wound areas including at least a first wound area and a second wound area in which winding states of the first wire and the second wire are different from each other are along the axis direction,
the first wound area includes
a first wound portion in which the first wire is wound in a direction from the first end portion toward the second end portion in the first layer,
a second wound portion in which the second wire is wound in a direction from the first end portion toward the second end portion in the second layer to a partway of a range of the first wound portion,
a first transfer portion in which winding direction of the second wire is changed from an end of the second wound portion on the second end portion side toward the first end portion side, and the second wire is guided to a position of the third layer,
a third wound portion in which the second wire is connected to the first transfer portion and is wound by N turns (N is a natural number) in the third layer,
a second transfer portion in which the second wire is guided from the third wound portion to a position of the first layer,
a fourth wound portion in which the second wire is connected to the second transfer portion and is wound toward the second end portion in the first layer,
a third transfer portion in which winding direction of the first wire is changed from an end of the first wound portion on the second end portion side toward the first end portion side, and the first wire is guided to a position of the second layer, and
a fifth wound portion in which the first wire is connected to the third transfer portion and is wound toward the second end portion in the second layer,
a position of each of the first wire and the second wire is switched between the first wound area and the second wound area,
the second wound area includes
a sixth wound portion in which the second wire is wound in a direction from the first end portion toward the second end portion in the first layer,
a seventh wound portion in which the first wire is wound in a direction from the first end portion toward the second end portion in the second layer to a partway of a range of the sixth wound portion,
a fourth transfer portion in which winding direction of the first wire is changed from an end of the seventh wound portion on the second end portion side toward the first end portion side, and the first wire is guided to a position of the third layer,
an eighth wound portion in which the first wire is connected to the fourth transfer portion and is wound by M turns (M is a natural number) in the third layer,
a fifth transfer portion in which the first wire is guided from the eighth wound portion to a position of the first layer,
a ninth wound portion in which the first wire is connected to the fifth transfer portion and is wound toward the second end portion in the first layer,
a sixth transfer portion in which winding direction of the second wire is changed from an end of the sixth wound portion on the second end portion side toward the first end portion side, and the second wire is guided to a position of the second layer, and
a tenth wound portion in which the second wire is connected to the sixth transfer portion and is wound toward the second end portion in the second layer, and
regarding a direction of a shift between the first wire and the second wire, when a shift in a positive direction is defined in a case where a turn of the second wire is closer to the second end portion side than a turn of the first wire with the same turn number as the turn of the second wire, and a shift in a negative direction is defined as in an opposite case,
a positive direction shift area in which a turn is shifted in the positive direction between the first wire and the second wire, and a negative direction shift area in which a turn is shifted in the negative direction between the first wire and the second wire, are in each of the first wound area and the second wound area.

6. A coil component comprising:
a core that includes a winding core portion having a first end portion and a second end portion opposite to each other in an axis direction; and
a first wire and a second wire spirally wound around the winding core portion and having substantially the same number of turns as each other, wherein
among a plurality of layers configured by the first wire and the second wire wound around the winding core portion, when a first layer is a layer closest to a peripheral surface of the winding core portion, a second layer is a layer wound on an outer peripheral side of the first layer while being fitted in a recessed portion between adjacent turns of a wire located in the first layer, and a third layer is a layer wound on an outer peripheral side of the second layer while being fitted in a recessed portion between adjacent turns of a wire located in the second layer,
a plurality of wound areas including at least a first wound area and a second wound area are along the axis direction,
the first wound area includes
a first wound portion in which the first wire is wound in a direction from the first end portion toward the second end portion in the first layer,
a second wound portion in which the second wire is wound in a direction from the first end portion toward the second end portion in the second layer to a partway of a range of the first wound portion,
a first transfer portion in which winding direction of the second wire is changed from an end of the second wound portion on a second end portion side toward a first end portion side, and the second wire is guided to a position of the third layer,
a third wound portion in which the second wire is connected to the first transfer portion and is wound by N turns (N is a natural number) in the third layer,
a second transfer portion in which the second wire is guided from the third wound portion to a position of the first layer,
a fourth wound portion in which the second wire is connected to the second transfer portion and is wound toward the second end portion in the first layer,
a third transfer portion in which winding direction of the first wire is changed from an end of the first wound portion on the second end portion side toward the first end portion side, and the first wire is guided to a position of the second layer, and
a fifth wound portion in which the first wire is connected to the third transfer portion and is wound toward the second end portion in the second layer,
a position of the first wire is switched between the first wound portion and the fifth wound portion, and position of the second wire is switched between the second wound portion and the fourth wound portion,
the second wound area includes
a sixth wound portion in which the first wire is wound in a direction from the first end portion toward the second end portion in the first layer,
a seventh wound portion in which the second wire is wound in a direction from the first end portion toward the second end portion in the second layer to a partway of a range of the sixth wound portion,
a fourth transfer portion in which winding direction of the second wire is changed from an end of the seventh wound portion on the second end portion side toward the first end portion side, and the second wire is guided to a position of the third layer,
an eighth wound portion in which the second wire is connected to the fourth transfer portion and is wound by M turns (M is a natural number) in the third layer,
a fifth transfer portion in which the second wire is guided from the eighth wound portion to a position of the first layer,
a ninth wound portion in which the second wire is connected to the fifth transfer portion and is wound toward the second end portion in the first layer,
a sixth transfer portion in which winding direction of the first wire is changed from an end of the sixth wound portion on the second end portion side toward the first end portion side, and the first wire is guided to a position of the second layer, and
a tenth wound portion in which the first wire is connected to the sixth transfer portion and is wound toward the second end portion in the second layer,
a position of the first wire is switched between the sixth wound portion and the tenth wound portion, and position of the second wire is switched between the seventh wound portion and the ninth wound portion, and
regarding a direction of a shift between the first wire and the second wire, when a shift in a positive direction is defined in a case where a turn of the second wire is closer to the second end portion side than a turn of the first wire with the same turn number as the turn of the second wire, and a shift in a negative direction is defined as in an opposite case,
a positive direction shift area in which a turn is shifted in the positive direction between the first wire and the second wire, and a negative direction shift area in which a turn is shifted in the negative direction between the first wire and the second wire, are in each of the first wound area and the second wound area.

7. The coil component according to claim 5, wherein
the negative direction shift area is on one of the first end portion side and the second end portion side of a boundary between the second wound portion and the fifth wound portion,
the positive direction shift area is on the other of the first end portion side and the second end portion side of the boundary between the second wound portion and the fifth wound portion,
the positive direction shift area is on one of the first end portion side and the second end portion side of a boundary between the seventh wound portion and the tenth wound portion, and
the negative-positive direction shift area is on the other of the first end portion side and the second end portion side of the boundary between the seventh wound portion and the tenth wound portion.

8. The coil component according to claim 7, wherein
a −0.5 turn shift area in which a turn is shifted by 0.5 turns in the negative direction between the first wire and the second wire is present, on one of the first end portion side and the second end portion side of the boundary between the second wound portion and the fifth wound portion,
a +(N−0.5) turn shift area in which a turn is shifted by (N−0.5) turns in the positive direction between the first wire and the second wire is present, on the other of the first end portion side and the second end portion side of the boundary between the second wound portion and the fifth wound portion,
a +0.5 turn shift area in which a turn is shifted by 0.5 turns in the positive direction between the first wire and the second wire is present, on one of the first end portion side and the second end portion side of the boundary between the seventh wound portion and the tenth wound portion, and
a −(N−0.5) turn shift area in which a turn is shifted by (N−0.5) turns in the negative direction between the first wire and the second wire is present, on the other of the first end portion side and the second end portion side of the boundary between the seventh wound portion and the tenth wound portion.

9. The coil component according to claim 7, wherein
a −0.5 turn shift area in which a turn is shifted by 0.5 turns in the negative direction between the first wire and the second wire is present, on one of the first end portion side and the second end portion side of the boundary between the second wound portion and the fifth wound portion,
a +(N+0.5) turn shift area in which a turn is shifted by (N+0.5) turns in the positive direction between the first wire and the second wire is present, on the other of the first end portion side and the second end portion side of the boundary between the second wound portion and the fifth wound portion,
a +0.5 turn shift area in which a turn is shifted by 0.5 turns in the positive direction between the first wire and the second wire is present, on one of the first end portion side and the second end portion side of the boundary between the seventh wound portion and the tenth wound portion, and
a −(M+0.5) turn shift area in which a turn is shifted by (M+0.5) turns in the negative direction between the first wire and the second wire is present, on the other of the first end portion side and the second end portion side of the boundary between the seventh wound portion and the tenth wound portion.

10. The coil component according to claim 5, wherein
the number of turns that the second wire is wound around the winding core portion in the third wound portion is different from the number of turns that the first wire is wound around the winding core portion in the eighth wound portion with each other.

11. The coil component according to claim 1, wherein
the second wire has a stepped portion at an end of the first wound portion on the first end portion side, such that the second wire is side by side with the first wire in the first layer, and the second wire is in contact with the peripheral surface of the winding core portion.

12. The coil component according to claim 6, wherein
the negative direction shift area is on one of the first end portion side and the second end portion side of a boundary between the second wound portion and the fifth wound portion,
the positive direction shift area is on the other of the first end portion side and the second end portion side of the boundary between the second wound portion and the fifth wound portion,
the positive direction shift area is on one of the first end portion side and the second end portion side of a boundary between the seventh wound portion and the tenth wound portion, and
the negative-positive direction shift area is on the other of the first end portion side and the second end portion side of the boundary between the seventh wound portion and the tenth wound portion.

13. The coil component according to claim 12, wherein
a −0.5 turn shift area in which a turn is shifted by 0.5 turns in the negative direction between the first wire and the second wire is present, on one of the first end portion side and the second end portion side of the boundary between the second wound portion and the fifth wound portion,
a +(N−0.5) turn shift area in which a turn is shifted by (N−0.5) turns in the positive direction between the first wire and the second wire is present, on the other of the first end portion side and the second end portion side of the boundary between the second wound portion and the fifth wound portion,
a +0.5 turn shift area in which a turn is shifted by 0.5 turns in the positive direction between the first wire and the second wire is present, on one of the first end portion side and the second end portion side of the boundary between the seventh wound portion and the tenth wound portion, and
a −(N−0.5) turn shift area in which a turn is shifted by (N−0.5) turns in the negative direction between the first wire and the second wire is present, on the other of the first end portion side and the second end portion side of the boundary between the seventh wound portion and the tenth wound portion.

14. The coil component according to claim 12, wherein
a −0.5 turn shift area in which a turn is shifted by 0.5 turns in the negative direction between the first wire and the second wire is present, on one of the first end portion side and the second end portion side of the boundary between the second wound portion and the fifth wound portion,
a +(N+0.5) turn shift area in which a turn is shifted by (N+0.5) turns in the positive direction between the first wire and the second wire is present, on the other of the first end portion side and the second end portion side of the boundary between the second wound portion and the fifth wound portion,
a +0.5 turn shift area in which a turn is shifted by 0.5 turns in the positive direction between the first wire and the second wire is present, on one of the first end portion side and the second end portion side of the boundary between the seventh wound portion and the tenth wound portion, and
a −(M+0.5) turn shift area in which a turn is shifted by (M+0.5) turns in the negative direction between the first wire and the second wire is present, on the other of the first end portion side and the second end portion side of the boundary between the seventh wound portion and the tenth wound portion.

15. The coil component according to claim 6, wherein
the number of turns that the second wire is wound around the winding core portion in the third wound portion is different from the number of turns that the first wire is wound around the winding core portion in the eighth wound portion with each other.

16. The coil component according to claim 5, wherein
the second wire has a stepped portion at an end of the first wound portion on the first end portion side, such that the second wire is side by side with the first wire in the first layer, and the second wire is in contact with the peripheral surface of the winding core portion.

17. The coil component according to claim 6, wherein
the second wire has a stepped portion at an end of the first wound portion on the first end portion side, such that the second wire is side by side with the first wire in the first layer, and the second wire is in contact with the peripheral surface of the winding core portion.
